(19) United States
(12) Patent Application Publication
(10) Pub. No.: US 2025/0182773 A1
(43) Pub. Date: Jun. 5, 2025

(54) METHODS AND APPARATUSES FOR SPEECH ENHANCEMENT

(71) Applicant: Comcast Cable Communications, LLC, Philadelphia, PA (US)

(72) Inventors: Scott Kurtz, Philadelphia, PA (US); Christian Buchter, Philadelphia, PA (US); James Merrill, Philadelphia, PA (US); Gary Skrabutenas, Philadelphia, PA (US); Philip Stick, Philadelphia, PA (US)

(21) Appl. No.: 18/526,712

(22) Filed: Dec. 1, 2023

(51) Int. Cl. G10L 21/0232; G10L 25/60

(52) U.S. Cl. CPC G10L 21/0232; G10L 25/60

(57) ABSTRACT

Methods, systems, apparatuses for speech enhancement are described. A computing device may receive sound inputs and reduce non-speech portions of the sound inputs based on a machine learning model.

### BACKGROUND

Stationary noise refers to a type of noise that remains relatively constant in its statistical properties over time. In other words, it is a noise signal whose characteristics, such as amplitude and frequency distribution, do not change significantly over time. Stationary noise reduction reduces noise whose spectral characteristics are wide-sense stationary or relatively constant over time. Examples of wide-sense stationary signals include white noise, pink noise, fan noise, motor noise, and even tones. However, existing methods and systems for stationary noise reduction fall short in that they do not reduce many types of noise and interference, such as a dog barking, keyboard clicking, a baby crying, reverberation, and music.

### SUMMARY

It is to be understood that both the following general description and the following detailed description are exemplary and explanatory only and are not restrictive. Methods, systems, and apparatuses for machine learning based speech enhancement are described. A computing device (e.g., user device or smart device) may receive sound inputs. The sound inputs may include speech and non-speech portions such as stationary noise and non-stationary noise. The computing device may convert the sound inputs (e.g., time domain signals) to time-frequency (TF) samples (e.g., frequency domain signals). The computing device may determine TF losses based on signal-to-noise (SNR) ratios (e.g., a-priori SNRs and a posteriori SNRs), speech probability estimates, etc. The speech probability estimates may be determined by a machine learning model. For example, the machine learning model may determine the speech probability estimates based on speech data, non-speech data, and/or speech and non-speech augmented data. The computing device may apply the TF losses to the TF samples to reduce the non-speech portions of the sound inputs. The computing device may generate sound outputs that include less non-speech portions than the sound inputs.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, show examples and together with the description, serve to explain the principles of the methods and systems:

FIG. 1 shows an example system;

FIG. 2 shows an example diagram;

FIG. 3 shows an example diagram;

FIG. 4 shows an example diagram;

FIG. 5 shows an example diagram;

FIG. 6 shows an example diagram;

FIG. 7 shows an example diagram;

FIG. 8 shows an example diagram;

FIG. 9 shows an example diagram;

FIG. 10 shows an example diagram;

FIG. 11 shows an example diagram;

FIG. 12 shows an example diagram;

FIG. 13 shows an example system;

FIG. 14 shows an example method;

FIG. 15 shows an example method;

FIG. 16 shows an example method;

FIG. 17 shows an example method; and

FIG. 18 shows an example system.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

Described herein are methods, systems, and apparatuses for machine learning based speech enhancements. For example, a computing device or a user device may determine, using machine learning, when to attenuate sound (e.g., non-speech) and when not to attenuate sound (e.g., speech) in voice/speech command detection. Various noise reduction or speech enhancement parameters such as machine learning estimated/inferenced speech probability, a time frequency loss, a Perceptual Evaluation of Speech Quality (PESQ) estimate, and/or a mean opinion score (MOS) may be used to determine whether speech exists in different frequency bands of the audio.

For example, a user device or a computing device may receive an input signal that comprises speech and non-speech. The non-speech may comprise stationary noise and non-stationary noise. The input signal may be converted to time-frequency (TF) samples (e.g., frequency domain signal) for further noise reduction/speech enhancement processing. The user device or the computing device may determine TF losses based on speech probability estimates. The speech probability estimates may be determined by a machine learning model. The speech probability estimates may indicate whether speech is present in the TF samples. The user device or the computing device may then apply the TF losses to the TF samples to attenuate the noise (or non-speech) and generate an output signal. The output signal may comprise less non-speech than the input signal.

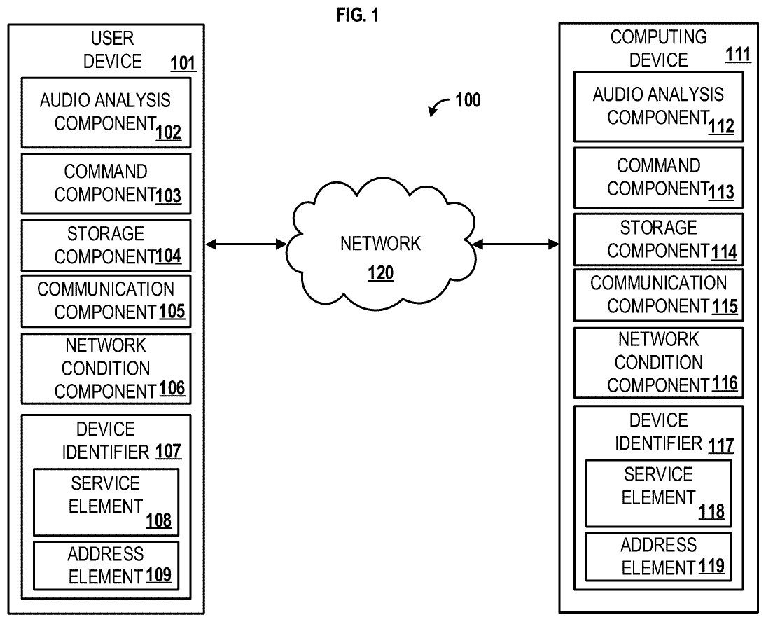

FIG. 1 shows an example system 100. The system 100 may comprise a user device 101 (e.g., a voice assistant device, a voice-enabled device, a smart device, a computing device, a smart TV, a set-top box, a voice-enabled remotes, a voice-enabled camera, etc.), a computing device 111 (e.g., a smart device, a voice-enabled device, a computer, a server, a content source, etc.), and a network 120. The network 120 may be a network such as the Internet, a wide area network, a local area network, a cellular network, a satellite network, and/or the like. Various forms of communications may occur via the network 120. The network 120 may comprise wired and wireless telecommunication channels, and wired and wireless communication techniques.

The user device 101 may comprise an audio analysis component 102, a command component 103, a storage component 104, a communication component 105, a network condition component 106, a device identifier 107, a service element 108, and an address element 109. The communications component 105 may be configured to communicate with (e.g., send and receive data to and from) other devices such as the computing device 111 via the network 120.

The audio analysis component 102 may be configured to receive audio data (e.g., a pulse code modulation (PCM) input signal). For example, the user device 101 may comprise a voice-enabled device. The user device 101 may comprise, for example, one or more microphones configured to detect audio. For example, a user may interact with the user device by pressing a button, speaking a wake word, or otherwise taking some action which activates the voice-enabled device. The audio data may comprise or otherwise be associated with one or more speech, non-speech, noise, noisy speech, utterances, one or more phonemes, one or more words, one or more phrases, one or more sentences, combinations thereof, and/or the like spoken by a user. The user device 101 may send the audio data to the computing device 111. The computing device 111 may receive the audio data (e.g., via the communications component 105). The user device 101 and/or the computing device 111 may process the audio data. Processing the audio data may comprise analog to digital conversion, digital signal processing, natural language processing, natural language understanding, sending or receiving one or more queries, executing one or more commands, filtering, noise reduction, combinations thereof, and/or the like. The audio analysis component 102 may be configured for automatic speech recognition (“ASR”). The audio analysis component 102 may apply one or more noise reduction algorithms or one or more speech enhancement algorithms to the received audio (e.g., speech, non-speech, etc.). The audio analysis component 102 may be configured for far-field voice recognition and/or far-field voice interaction, which enables the user device 101 and/or the computing device 111 to receive and accurately interpret spoken commands or queries from a distance, for example, across a room or in a noisy environment. The audio analysis component 102 may be configured for full-duplex communication, which enables the user device 101 and/or the computing device 111 to both receive voice commands or queries form a user and provide a response or feedback to the user simultaneously for seamless and natural interaction between the user and the user device 101 and/or the computing device 111.

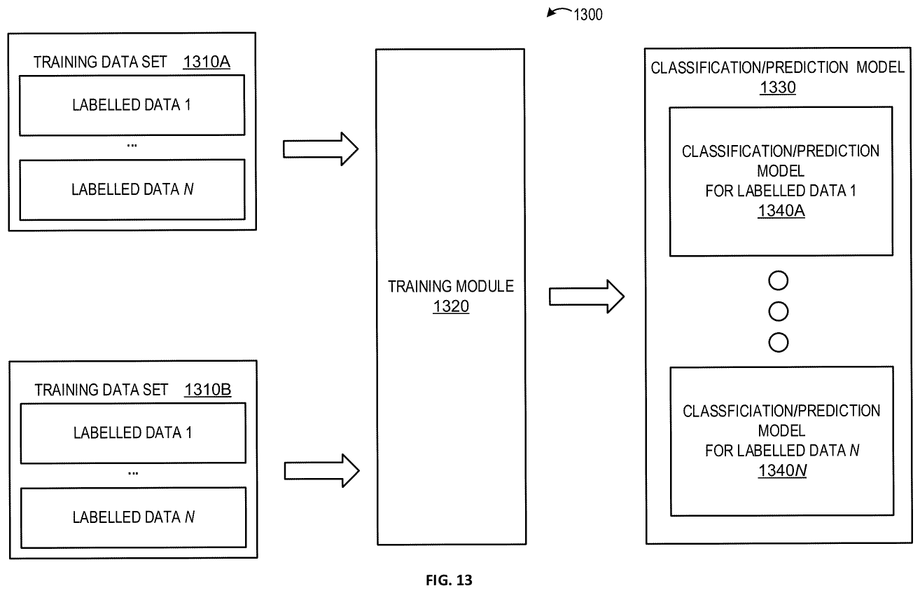

The audio analysis component 102 may perform methods for noise reduction or speech enhancement. For example, the audio analysis component 102 may receive an input signal (e.g., time domain signal) that comprises speech and non-speech. The input signal may be a pulse code modulation (PCM) signal. The non-speech may comprise stationary noise and non-stationary noise. The non-stationary noise may refer to a type of noise that does not have a constant statistical distribution or properties over time. Examples of the non-stationary noise may include, but are not limited to, a dog barking, keyboard clicking, a baby crying, music, traffic, wind, and background conversation. The audio analysis component 102 may convert the input signal (e.g., time domain signal) to a set of time-frequency (TF) samples (e.g., frequency domain signals), for example, using techniques such as subband encoding, Fast Fourier Transform, or the like. The audio analysis component 102 may determine the speech probability estimate for each TF sample. For example, the audio analysis component 102 may determine the speech probability estimate for each TF sample based on the set of TF samples. The speech probability estimate for the each TF sample (of the set of TF samples) may indicate whether speech is present in each TF sample (of the set of TF samples). The speech probability estimate may further distinguish the speech from the stationary noise and the non-stationary noise. The speech probability estimate may be provided by a machine learning model. For example, as further described herein, the machine learning model may be trained to output speech probability estimates based on training data comprising one or more input features and one or more indications or labels indicating whether speech is present or not. The machine learning model, the training data, etc. may be stored or accessible by the user device 101 and/or the computing device 111. The audio analysis component 102 may include the training module 1320 (as shown in FIG. 13) to determine the machine learning model based on the training data.

The audio analysis component 102 may determine one or more TF losses. For example, the audio analysis component 102 may determine the one or more TF losses based on the speech probability estimate for each TF sample of the set of TF samples. The one or more TF losses may be applied to one or more TF samples of the set of TF samples for noise reduction and/or speech enhancement. For example, each TF sample may represent a frequency bin, and the audio analysis component 102 may apply the TF losses to each frequency bin. Little to no loss may be applied to frequency bins that are deemed not to be noise. More loss may be applied to frequency bins that are deemed to be noise. For example, more TF loss may be applied to a TF sample associated with a frequency bin and a noise-reduced sample may be generated. The audio analysis component 102 may provide the noise-reduced TF samples to a frequency-to-time domain converter. The noise-reduced TF samples (e.g., frequency domain signals) may be converted to time domain signals. For example, the frequency-to-time domain converter may convert the noise-reduced TF samples to the time domain signals using subband synthesis, inverse Fast Fourier Transform (FFT), and/or inverse wavelet transform. The audio analysis component 102 may generate an output signal. For example, the audio analysis component 102 may generate the output signal (e.g., a noise reduced PCM sample stream) based on the time domain signals converted from the noised-reduced TF samples.

The machine learning model that estimates the speech probability may be trained with various parameters or data sets. For example, a data set may include extracted signal features tied to the labels indicating whether speech is present or not. Examples of the extracted features may comprise Mel Frequency Cepstrum Coefficients (MFCCs), TF samples, and/or any combination thereof. For example, the extracted features for training and using the machine learning model may be the TF samples themselves. The MFCCs may comprise a set of features to distinguish between speech and non-speech but some details may need to be removed in the computation of the MFCCs to sufficiently determine TF losses. By way of example, there may be multiple MFCCs (e.g., 13 MFCCs) per analysis frame while there may be multiple TF samples/losses (e.g., 256 TF samples/losses) per frame. As an example, the 13 MFCCs may or may not provide sufficient detail to compute 256 TF samples/losses. Alternatively or additionally, the machine learning model may also directly estimate TF losses based on a data set that ties the extracted signal features to the TF losses. The training process for the machine learning model may be performed with the PESQ estimates or MOS scores as a cost function to determine the best machine learning model that estimates the TF losses.

The command component 103 may receive audio files (e.g., an input signal that comprises speech and non-speech). The command component 103 may be configured for NLP and/or NLU and may determine, for example, one or more keywords or key phrases contained in the audio files. Based on the one or more keywords, the command component 103 may determine one or more operational commands. The user device 101 may detect one or more wake words determine one or more operational commands. The one or more operational commands may comprise one or more channels, one or more operations (e.g., “tune to,” “record,” “play,” etc.), one or more content titles, combinations thereof, and/or the like. The command component 103 may determine whether a phoneme, phonetic sound, word, and/or words extracted/determined from the audio data match a stored phoneme, phonetic sound, word, and/or words associated with an operational command of the one or more operational commands. The command component 103 may determine whether the audio data includes a phoneme, phonetic sound, word, and/or words that correspond to and/or are otherwise associated with the one or more wake words or one or more operational commands.

The network condition component 106 may be configured to determine one or more network conditions such as network traffic, packet loss, noise, upload speeds, download speed, combinations thereof, and/or the like.

The computing device 111 may comprise an audio analysis component 112, a command component 113, a storage component 114, a communications component 115, a device identifier 117, a service element 118, and an address element 119. The storage component may be configured to store audio data associated with one or more audio/noise sources (e.g., speech from one or more users or non-speech from the environment associated with the one or more users). The one or more audio profiles may comprise historical audio data such as voice signatures or other characteristics associated with the one or more users. For example, the one or more audio profiles may be determined (e.g., created, stored, recorded) during configuration or may be received (e.g., imported) from storage.

The audio analysis component 112 may comprise or otherwise be in communication with the one or more microphones. The one or more microphones may be configured to receive the one or more audio inputs. The audio analysis component 112 may be configured to detect the one or more audio inputs. The one or more audio inputs may comprise audio originating from (e.g., caused by) one or more audio sources. The one or more audio sources may comprise, for example, one or more people, one or more devices, the environment associated with the one or more people or one or more devices, one or more machines, combinations thereof, and/or the like. The audio analysis component 112 may be configured to convert the analog signal to a digital signal for noise reduction or speech enhancement. For example, the audio analysis component 112 may comprise an analog to digital converter.

The audio analysis component 112 may perform methods for noise reduction or speech enhancement. For example, the audio analysis component 112 may receive an input signal that comprises speech and non-speech. The input signal may be a pulse code modulation (PCM) signal. The non-speech may comprise stationary noise and non-stationary noise. The non-stationary noise may refer to a type of noise that does not have a constant statistical distribution or properties over time. The audio analysis component 112 may convert the input signal (e.g., time domain signal) to a set of time-frequency (TF) samples (e.g., frequency domain signals), for example, using techniques such as subband encoding, Fast Fourier Transform, or the like. The audio analysis component 112 may determine the speech probability estimate for each TF sample. For example, the audio analysis component 112 may determine the speech probability estimate for each TF sample based on the set of TF samples. The speech probability estimate for the each TF sample (of the set of TF samples) may indicate whether speech is present in each TF sample (of the set of TF samples). The speech probability estimate may further distinguish the speech from the stationary noise and the non-stationary noise. The speech probability estimate may be provided by a machine learning model based on a labelled data set via the communication component 116. The labelled data set may comprise one or more input features and one or more indications or labels indicating whether speech is present or not.

The audio analysis component 112 may determine one or more TF losses. For example, the audio analysis component 112 may determine the one or more TF losses based on the speech probability estimate for each TF sample of the set of TF samples. The one or more TF losses may be applied to one or more TF samples of the set of TF samples for noise reduction or speech enhancement. For example, the audio analysis component 112 may apply the TF losses to each frequency bin on a per-frame basis. Little to no loss may be applied to frequency bins that are deemed not to be noise. More loss may be applied to frequency bins that are deemed to be noise. The audio analysis component 112 may provide the noise-reduced TF samples to a frequency-to-time domain converter. For example, the frequency-to-time domain converter may convert the noise-reduced TF samples (e.g., frequency domain signals) to time domain signals, using subband synthesis, inverse FFT, and/or inverse wavelet transform. The audio analysis component 112 may generate an output signal. For example, the audio analysis component 112 may generate the output signal (e.g., a noise reduced PCM sample stream) based on the time domain signals converted from the noised-reduced TF samples.

The machine learning model that estimates the speech probability may be trained with various parameters or data sets. For example, a data set may include extracted signal features (e.g., Mel Frequency Cepstrum Coefficients (MFCCs), Phonemes, Senones, and/or Mel Spectrogram) tied to the labels indicating whether speech is present or not. Alternatively or additionally, the machine learning model may also directly estimates the TF losses based on a data set that ties the extracted signal features to TF losses. The training process for the machine learning model may be performed with the PESQ estimates or MOS scores as a cost function to determine a best machine learning model that estimates the TF losses.

For example, the audio analysis component 112 may determine audio originating from a user speaking in proximity to the user device 111. The one or more audio inputs may be speech that originates from and/or may be caused by a user, a device (e.g., a television, a radio, a computing device, etc.), and/or the like.

The audio analysis component 112 may be configured to determine one or more wake words and/or portions thereof and/or one or more utterances including, for example, one or more operational commands. For example, the audio analysis component 112 may determine the one or more wake words and/or portions thereof and/or the one or more utterances based on the detected audio. The one or more operational commands may be associated with the one or more utterances.

The network condition component 116 may be configured to determine one or more network conditions such as network traffic, packet loss, noise, upload speeds, download speed, combinations thereof, and/or the like. For example, the network condition component 116 may adjust the wake word confidence threshold required to determine a wake word detect event, the beginning of the wake word, or the end of the wake word. For example, during periods when the network is experiencing high packet loss, the network condition component 116 may reduce the wake word confidence threshold so as to make it easier to generate a detect event.

The computing device 111 may be associated with a device identifier 117. The device identifier 117 may be any identifier, token, character, string, or the like, for differentiating one computing device (e.g., the computing device 111, etc.) from another user device. The device identifier 117 may identify computing device 111 as belonging to a particular class of user devices. The device identifier 117 may include information relating to the computing device 111 such as a manufacturer, a model or type of device, a service provider associated with the computing device 111, a state of the computing device 111, a locator, and/or a label or classifier. Other information may be represented by the device identifier 117.

The device identifier 117 may have a service element 118 and an address element 119. The service element 118 may have or provide an internet protocol address, a network address, a media access control (MAC) address, an Internet address, or the like. The address service 118 may be relied upon to establish a communication session between the computing device 111, the user device 101, or other devices and/or networks. The address element 119 may be used as an identifier or locator of the user device 101. The address element 119 may be persistent for a particular network (e.g., network 120, etc.).

The service element 118 may identify a service provider associated with the computing device 111 and/or with the class of the computing device 111. The class of the computing device 111 may be related to a type of device, a capability of a device, a type of service being provided, and/or a level of service (e.g., business class, service tier, service package, etc.). The service element 118 may have information relating to and/or provided by a communication service provider (e.g., Internet service provider) that is providing or enabling data flow such as communication services to the computing device 111. The service element 118 may have information relating to a preferred service provider for one or more particular services relating to the computing device 111. The address element 119 may be used to identify or retrieve data from the service element 118, or vice versa. One or more of the address element 119 and the service element 118 may be stored remotely from the computing device 111 and retrieved by one or more devices such as the computing device 111, the user device 101, or any other device. Other information may be represented by the service element 118.

The computing device 111 may include a communication component 115 for providing an interface to a user to interact with the user device 101. The communication component 115 may be any interface for presenting and/or receiving information to/from the user, such as user feedback. An interface may be communication interface such as a television (e.g., voice control device such as a remote, navigable menu or similar), web browser (e.g., Internet Explorer®, Mozilla Firefox®, Google Chrome®, Safari®, or the like). The communication component 115 may request or query various files from a local source and/or a remote source. The communication component 115 may transmit and/or data, such as audio content, telemetry data, network status information, and/or the like to a local or remote device such as the user device 101. For example, the user device 101 may interact with a user via a speaker configured to sound alert tones or audio messages. The user device 101 may be configured to display a microphone icon (or similar) when it is determined that a user is speaking. The user device 101 may be configured to display or otherwise output one or more error messages or other feedback based on what the user has said.

For voice communication products such smart TVs, set-top boxes, voice enabled remotes, and voice enabled camera, the stationary noise reduction is effective at reducing noise whose spectral characteristics are wide-sense stationary or relatively constant over time. Examples of wide-sense stationary signals may include white noise, pink noise, fan noise, motor noise, and even tones. Examples of sounds that are not stationary may include human speech, a dog barking, keyboard clicking, a baby crying, and music. However, stationary noise reduction falls short in that it does not reduce many of non-stationary types of noise and interference such dog barking, keyboard clicking, baby crying, music, and reverberation.

Machine learning (ML)-based speech enhancement (or noise reduction) may be discussed throughout this disclosure. For example, three ML-based speech enhancements may be described herein. In the stationary noise reduction, the input signal may be analyzed using standard signal processing techniques in order to estimate metrics such as (e.g., per frequency) signal level, noise level, signal to noise ratio, probability of noise, etc. Those metrics may be sent to the noise reduction for the purpose of computing the per-frequency losses to apply to the spectrum of the signal with the goal of reducing noise. Below equation (1) may represent the noise reduction:

L[i]=f(signal level, noise level, snr, probability of noise, etc.) Equation(1)

where L is the per-frequency bin loss and i spans the number of frequency bins. f( ) represents the predefined function for the noise reduction.

In equation (1), the function f( ) may be predetermined or predefined. The input parameters or features may be sent to the function f( ) and per-frequency losses may be obtained or predicted. ML-based speech enhancement may start with a large set of labelled data. The labelled data may be a set of inputs (e.g., features) and corresponding known outputs associated with those features. A machine learning model may then determine the function f( ) that when given a set of unknown features, the machine learning model may predict the output.

As described above, the ML-based speech enhancement may start with a set of known features and their associated outputs, and may produce function f( ) for noise reduction or speech enhancement. In the example of wake word detection, labelled data may include two sets of data, for example, positive data and negative data. The positive data may be a set of audio files that includes the wake word. These audio files may be labelled as a one (1). The negative data set may include audio files that do not have the wake word. These audio files may be labelled as a zero (0).

The machine learning may use these data to devise a model that, when sent with the training data, it is able to distinguish between a wake word (1) and a non-wake word (0). That model may then be deployed in a device to distinguish the wake word and non-wake word. The training may be based upon the classical gradient descent minimization technique that minimizes a cost function. The cost function may represent the probability that a model makes a mistake in classifying the input. That is, if the model infers that a negative input sample includes the wake word (e.g., false positive) or the model infers that the a positive sample does not include the wake word (e.g., false negative), the total cost may be increased. When the model infers correctly, the total cost may not be increased.

For example, if the training set includes 10,000 positive samples and 20,000 negative samples and it makes every decision incorrectly, the cost may be 30,000 (e.g., 10,000 false negatives and 20,000 false positives.) If the model has 10 false positives and 20 false negatives, the cost may be 30. More complex cost functions may be created, for example, by giving weight to the false positives and false negatives differently. Thus, one type of mistake may have worse consequences than the other.

In the ML-based speech enhancement (or noise reduction), the probability of noise estimator may be replaced with a probability of speech estimator. While the stationary noise reduction is limited to applying loss based upon raw signal to stationary noise characteristics, the addition of a speech detector may enable the ML-based noise reduction to apply loss based on the decision as to whether the signal includes speech or does not include speech. The signal can therefore be enhanced when the interference is non-stationary. In the case of the dog barking example, the ML-based noise reduction is able to identify when the dog is barking or not, and therefore attenuation may be applied to the dog barking signal.

A machine learning model may be trained to distinguish between human speech and some predefined sets of interferer types such as a dog barking, a baby crying, background chatter, reverberation, etc. The machine learning inference may become the probability of speech detector, outputting a value between 0.0 and 1.0. The value between 0.0 and 1.0 may indicate the probability that the current signal includes human speech or interference. This probability may then be used to determine the per-frequency-bin losses.

The labelled data for the machine learning model may comprise speech data samples (e.g., each labelled 1) and non-speech samples (e.g., each labelled 0). A third category, speech plus non-speech samples (e.g., noisy speech), may be included. Based upon the speech to non-speech signal ratio, the speech plus non-speech samples may be labelled as a 1 or a 0. This third category of speech plus non-speech samples may be created by combining the speech data with the non-speech data with different weights applied to each. This process may refer to as augmenting a data set. By augmenting the data set, the need to capture live data that naturally includes speech plus non-speech samples may be precluded.

For example, if the speech level (or speech weight) is greater than the non-speech level (or non-speech weight), a 1 may be labelled. However, if the non-speech level (or non-speech weight) is greater than the speech level (or speech weight), a 0 may be labelled because the signal is so unintelligible that the desired signal cannot be extracted. By assigning a 0, the non-speech portion or the speech plus non-speech samples may be attenuated aggressively. For example, if the non-speech is a loud dog bark that eclipses some speech, non-speech may be aggressively removed so that the output has little to no dog bark sound in it.

The machine learning model may be trained with various parameters or data sets. For example, a data set may include extracted signal features (e.g., Mel Frequency Cepstrum Coefficients (MFCCs), Phonemes, Senones, and/or Mel Spectrogram) tied to labels indicating whether speech is present or not. Alternatively or additionally, the machine learning model may also directly estimate the TF losses based on a data set that ties the extracted signal features to TF losses. The training process for the machine learning model may be performed with the PESQ estimates or MOS scores as a cost function. For example, the PESQ estimates or MOS produced by a machine learning model during a current epoch may be evaluated with a previous PESQ estimate(s) or MOS produced by another machine learning model during a previous epoch to determine a best machine learning model to estimate the TF losses.

Perceptual Evaluation of Speech Quality (PESQ) may be a method for assessing the perceived quality of speech signals after the speech signals have been subjected to various forms of degradation, such as compression, noise, or other forms of signal processing. In other words, it may be a method to estimate subjective speech quality of a degraded speech sample by comparing it with the original clean speech. PESQ may be used to evaluate the impact of such degradations on the subjective quality of speech as perceived by human listeners. PESQ aims to provide an objective measurement of the perceived quality of speech, taking into account factors such as distortion, noise, and other impairments that can affect the intelligibility and naturalness of speech signals. The method involves comparing the degraded speech signal with a reference (usually the original, undegraded signal) and assigning a quality score based on how closely the degraded signal matches the reference in terms of perceptual quality. PESQ may operate by simulating the human auditory system's perception of speech quality. It may use psychoacoustic models to predict how a typical human listener would perceive the degraded speech. The output of PESQ may be a quality score typically expressed on a scale from −0.5 to 4.5 (or 1 to 5), where higher scores indicate better perceived quality.

It is noted that PESQ is not the only method for objectively predicting subjective speech quality. There are other methods that can be used to assess the speech quality related to the methods, apparatuses, and systems disclosed herein.

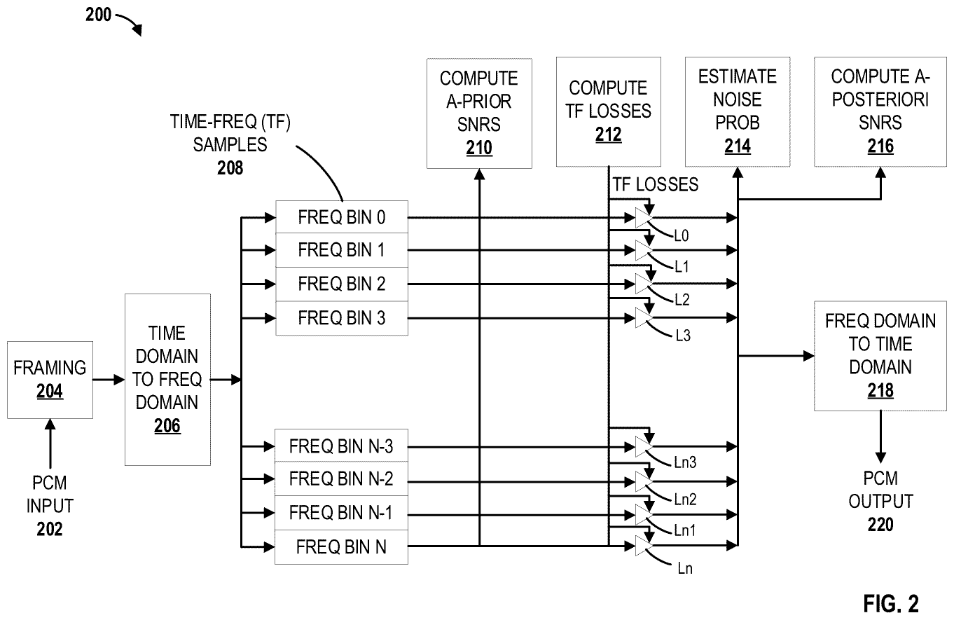

Stationary noise reduction may reduce stationary noise by attenuating frequency bands that exhibit a low signal-to-noise ratio (SNR). FIG. 2 shows an example diagram 200 for stationary noise reduction. As shown in FIG. 2, the user device 101 or the computing device 111 may receive an input signal 202 that comprise speech and non-speech. The input signal 202 may be a pulse code modulation (PCM) signal. The PCM signal may be a discrete digital signal sampled/quantized/encoded based on analog signals using the PCM technique. At block 204, the input signal 202 may be divided into one or more frames. For example, a continuous stream of the input signal 202 (e.g., PCM-coded samples) may be divided into discrete segments or frames. Each frame may comprise a fixed number of PCM samples and may be 10 to 20 milliseconds long.

At block 206, each frame of the input signal 202 (e.g., time domain signals) may be converted to the frequency domain signals using subband encoding and/or a mathematical transformation such as Fast Fourier Transform. The frequency domain may be represented by a set of N complex time-frequency (TF) samples 208, where N is a frame size. For example, if the frame size is 256 samples and the sampling rate is 16 kHz, a subband encoder may output 256 time-frequency (TF) samples. Each TF sample may represent a narrow frequency bin whose width is 31.25 Hz (e.g., 16000/2/256=31.25 Hz). The TF samples 208 may be uniformly spaced for stationary noise reduction. For example, if a wavelet encoder is used as the time domain to frequency domain converter, the frequency bins may be spaced in octaves and there may be far fewer number of frequency bins.

At block 210, an a-priori signal to noise ratio (SNR) may be determined. The a-priori SNR may be determined based on the TF samples 208. For example, the user device 101 or the computing device 111 may determine a per-frequency-bin a-priori SNR. The term a-priori may refer to the SNR determined based upon the signal prior to noise reduction. The signal energy may be a short-term estimate using the complex TF samples. The per-frequency-bin noise estimate may be based upon a recent history of per-bin TF samples. In particular, the noise estimate may be a minimum TF power for a given frequency bin during a period of time (e.g., a period of a few seconds).

At block 212, Time-Frequency (TF) losses may be determined. The TF loss may refer to the potential loss or alteration of time-frequency details in a signal that can occur when applying noise reduction techniques to remove unwanted noise. The user device 101 or the computing device 111 may apply the TF losses to each frequency bin on a per-frame basis. For example, little to no loss may be applied to frequency bins that are deemed not to be noise. More loss may be applied to frequency bins that are deemed to be noise. The TF losses may be determined based upon a current a-priori SNR (e.g., determined at block 210), a noise probability estimate (e.g., determined at block 214), and/or a previous a-posteriori SNR. The term a-posteriori may refer to the SNR determined based upon the signal after noise reduction. The noise probability estimate (e.g., at block 214) may be between 0 and 1. The noise probability estimate (e.g., at block 214) may be determined based upon the noise-reduced signal (e.g., the noise reduced signals from the attenuation triangles L0-LN shown in FIG. 2). Alternatively or additionally, the noise probability estimate (e.g., at block 214) may be determined based on, at least in part, the signal in its original form (e.g., prior to being noise-reduced). The a-posteriori SNR (e.g., at block 216) may be determined based upon the noise reduced signal.

At block 218, the noise-reduced TF samples may be sent to a frequency-to-time domain converter. For example, the user device 101 or the computing device 111 may convert the noise-reduced TF samples (e.g., frequency domain signals) to time domain signals using subband synthesis, inverse FFT, and/or inverse wavelet transform. At block 220, an output signal (e.g., a noise reduced PCM time domain sample stream) may be generated. For example, the output signal may be generated based on the conversion of the noise-reduced TF samples to the time domain signals.

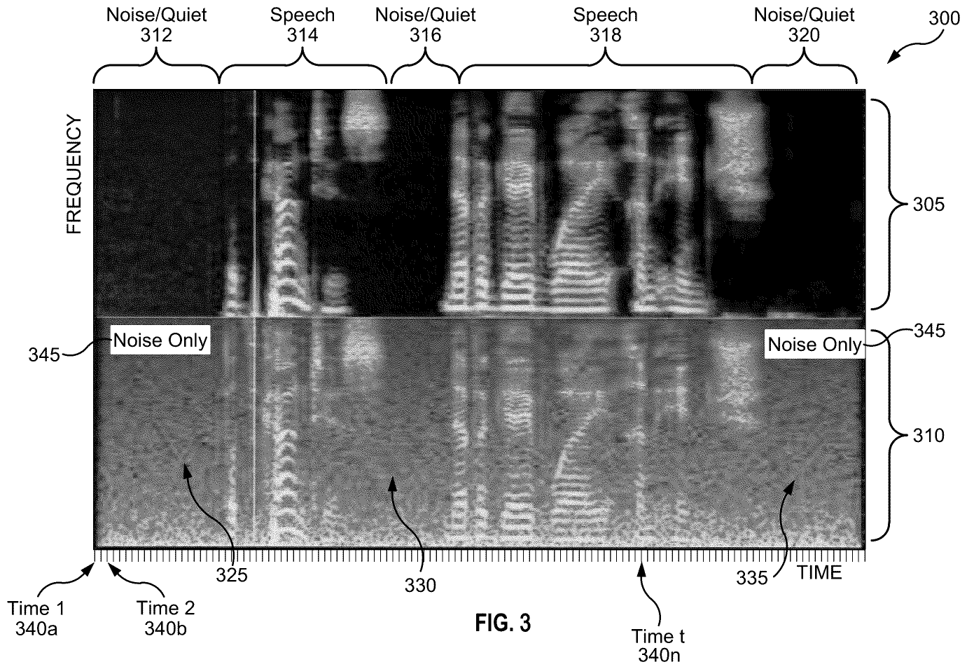

FIG. 3 shows example spectrograms 300 for noise reduction. The spectrogram 305 shows clean speech and the spectrogram 310 shows speech with stationary noise. In the spectrograms 300, time may be represented by the horizontal axis and frequency may be represented by the vertical axis. In addition, amplitude may be represented by brightness.

In spectrogram 305, speech regions/areas/segments 314, 318 are distinguished from noise/quiet regions/areas/segments 312, 316, 320. The speech regions 314, 318 are brighter than the noise/quiet regions 312, 316, 320. The noise/quiet regions 312, 316, 320 are darker across the entire spectrum (e.g., across spectrograms 305, 310 from bottom to top). In spectrogram 310, those dark regions 312, 316, 320 in the spectrogram 305 are instead brighter, but generally not as bright as the speech regions 314, 318. The speech may have short horizontal spectral “lines” indicating that there is somewhat constant and pronounced spectral content in the short term. However, the noise may not change much over time (e.g., stationary).

In the stationary noise reduction, the time-frequency losses may be applied at every time period where a time period is a narrow vertical slice of FIG. 3 (e.g., time 1-n, 340a-n). Stationary noise areas (e.g., areas 325, 330, 335) are more attenuated while the bright areas (e.g., speech areas 314, 318) are attenuated less. Specifically, the noise may be characterized at each frequency by measuring the minimum power in each frequency bin during the stationary periods. Using those noise measurements, the SNR at each frequency may be subsequently measured in each narrow vertical slice of time (e.g., time 1-n, 340a-n). A bright area (e.g., speech areas 314, 318) has a high signal to noise ratio. Little to no attenuation may be applied in the bright area (e.g., speech areas 314, 318). In an area where the brightness is no more than the background noise brightness (e.g., noise only area 345), the attenuation may be aggressively applied.

The goal of the noise reduction is that the noise-reduced signal resembles the original signal. For example, the noise reduction may reduce noise signals shown in the spectrogram 310 and make it resemble to the noised reduced signals shown in the spectrogram 305.

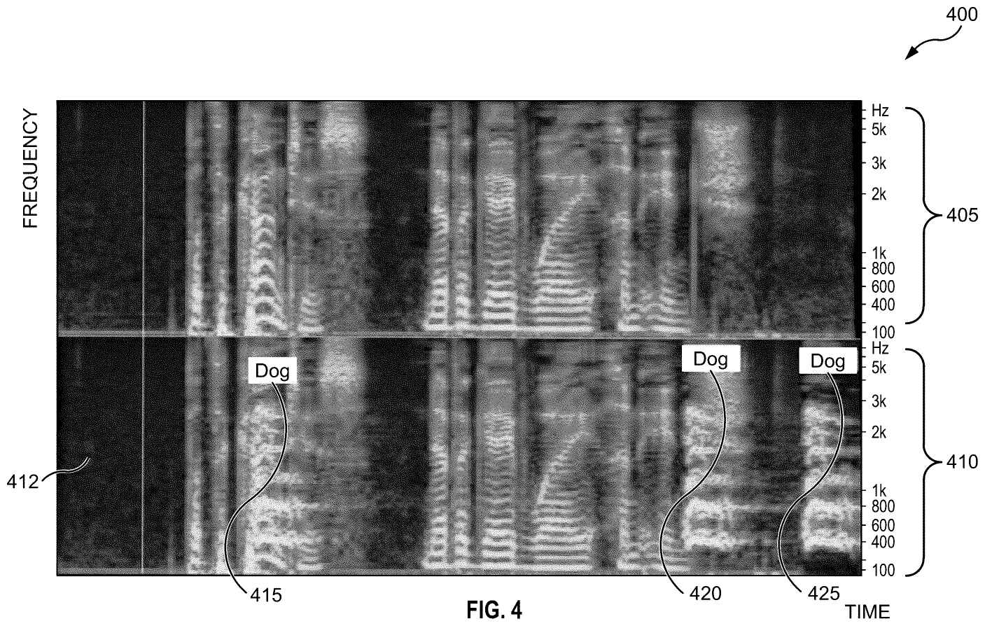

FIG. 4 shows example spectrograms 400 for noise reduction. The spectrogram 405 shows clean speech and the spectrogram 410 shows speech plus a dog barking. In the spectrogram 400, time may be represented by the horizontal axis and frequency may be represented by the vertical axis. In addition, amplitude may be represented by brightness.

Area 415 includes a dog barking plus speech. Areas 420, 425 include dog barking only. The dog barking is not stationary noise in that it is not constant in time. Just looking at the spectrogram 410 and comparing the brightness of the dog sections 415, 420, 425 to the brightness of the dark noise-only sections (e.g., area 412), the signal to stationary noise ratio of the dog barking is close to the signal to noise ratio of the speech. Thus, a stationary noise reduction will not attenuate non-stationary noise such as the dog barking sound.

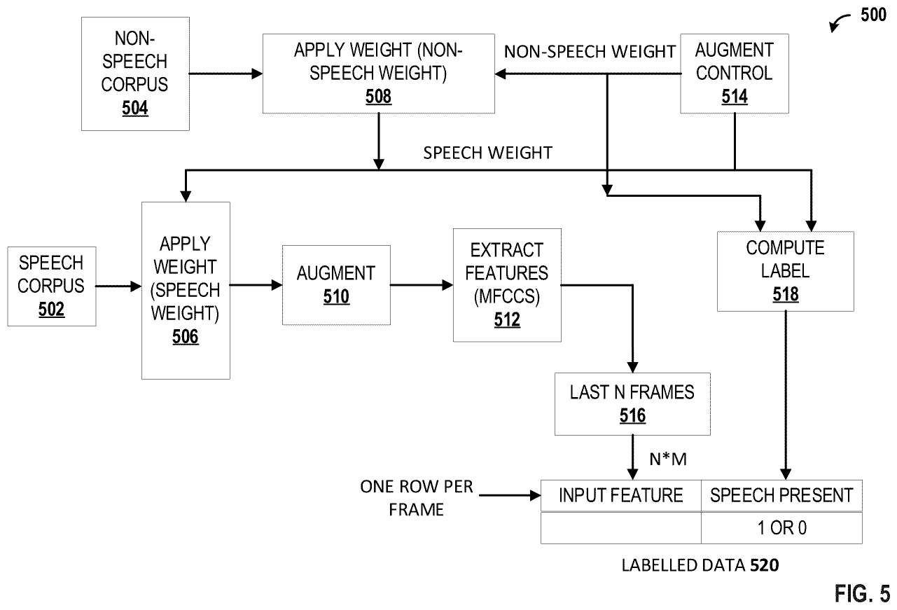

FIG. 5 shows an example labelling process 500 for noise reduction. The labelling process 500 may start with a speech corpus and a non-speech corpus at blocks 502, 504. The speech corpus may be a set of audio files that include speech only. The non-speech corpus may be a set of audio files that includes sounds that do not include speech but include one or more types of interference to be removed. The one or more types of interference to be removed may comprise stationary noise and non-stationary noise. Examples of the non-stationary noise may include, but are not limited to, a dog barking, keyboard clicking, a baby crying, music, traffic, wind, reverberation, and background conversation. The reverberation may refer to one or more impairments in the audio files. Presumably in a real environment, there may be times when the speech is louder than the non-speech and there may be times when the non-speech is louder than the speech. Thus, when augmenting the speech, different amounts of gain or loss may be applied to the speech as well as the non-speech at blocks 506, 508. The weighted speech and the weighted non-speech may be combined at block 510 (e.g., augment block). Alternatively or additionally, the augment block 510 may augment the speech data by introducing reverberation, pitch changes, tempo changes, or the like to make the speech corpus more general.

At block 512, one or more features may be extracted from the augmented speech. The features may be Mel Frequency Cepstrum Coefficients (MFCCs) Phonemes, Senones, and/or Mel Spectrogram. The extraction of features may be performed on a frame-by-frame basis where the frame size may be 20 milliseconds. At block 516, the most recent N frames of M per-frame MFCCs may be tracked. This is because a speech vs. non-speech decision may not be made based upon a short 20 millisecond sample of speech. The features N*M MFCCs may be stored in the labelled data 520 for each frame in the input features column. The label column of the table may be titled “speech present” where a 1 indicates that speech is present and predominant, and a 0 indicates that non-speech is predominant. The label block 518 may make that determination based upon relative weights, received from various blocks 506, 508, 514.

The machine learning model may be trained with the labelled data 520. The cost function may increment in case of false positive or false negative samples. For example, the cost function may increment whenever the machine learning model falsely determines/indicates that speech was present when it was not or when the machine learning model falsely determines/indicates that speech was not present when it was. As describe above, the machine learning model that is determined by the training process with the labelled data 520 may become part of noise reduction methods described herein.

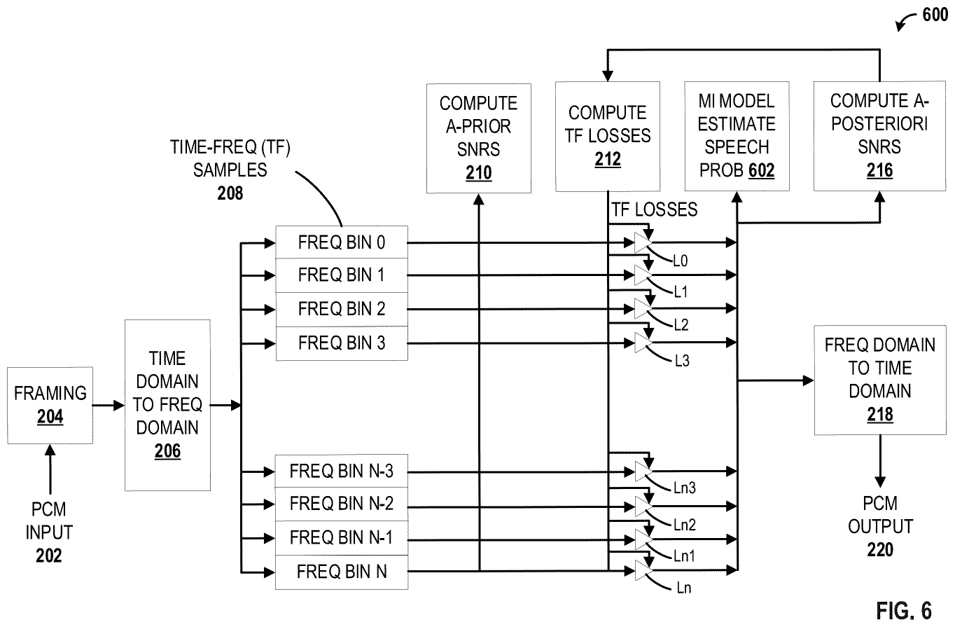

FIG. 6 shows an example method 600 for noise reduction with speech probability estimated based on the ML model. The blocks and signals 202-212 and 216-220 shown in FIG. 6 are the same as or substantially similar to those shown in FIG. 2 and are not described herein for brevity. At block 602, a ML model trained with the labelled data 520 may provide the probability of speech being used to determine the TF losses at block 212 for noise reduction.

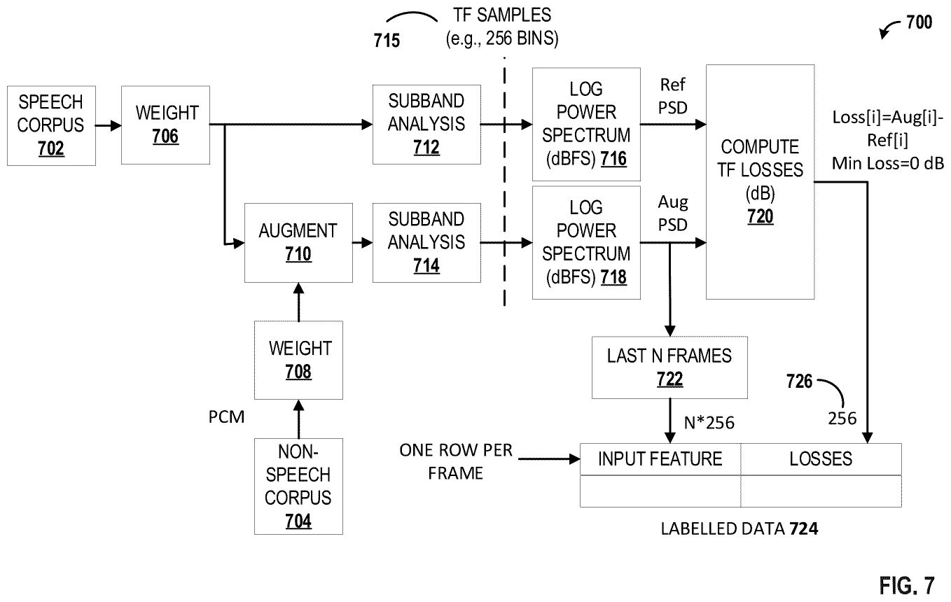

FIG. 7 shows an example labelling process 700 for noise reduction. The machine learning speech enhancement methods described in FIGS. 5-6 may classify audio as speech vs. non-speech. The speech probability that is estimated by the machine learning model may be used to determine time-frequency (TF) losses. In FIG. 7, a machine learning model may directly estimate the TF losses. In order to do that, a set of labelled data that ties features to TF losses may be needed.

The labelling process 700 may start with a speech corpus and a non-speech corpus at blocks 702, 704. At block 702, the speech corpus may be received. For example, the machine learning model configured to estimate the TF losses may receive the speech corpus to generate labelled data. The speech corpus may be a set of audio files that include speech only. At block 704, the non-speech corpus may be received. For example, the machine learning model configured to estimate the TF losses may receive the non-speech corpus to generate labelled data. The non-speech corpus may be a set of audio files that includes sounds that do not include speech but include the types of interference to be removed. At blocks 706, varying weights may be applied to the speech. At block 708, varying weights may be applied to the non-speech. The weighted results may be augmented at block 710. At block 710, the weighted speech and non-speech signals may be added together. At block 710, other augmentation such as reverberation, pitch shift, and/or tempo shift to the inputs may be applied. A set of speech data may be augmented by taking each speech audio clip and adding a variety of permutations of non-speech audio, thereby resulting in one or more augmented audio samples for each individual speech sample. Similarly, a set of non-speech data may be augmented by taking each non-speech audio clip and adding a variety of permutations of speech audio, thereby resulting in one or more augmented audio samples for each individual non-speech sample.

The weighted speech at block 706 and augmented signal at block 710 may be sent to subband analysis (or FFT) at blocks 712, 714 respectively to convert the weighted speech and the augmented signal to time-frequency samples 715. For example, at Log Power Spectrum blocks 716, 718, the TF samples 715 may be converted to power in dB scaling. The output of the Log Power Spectrum block 716 may be the Reference Power Spectral Density (PSD), corresponding to the PSD of the speech. The output of the Log Power Spectrum block 718 may be the augmented PSD. It may be assumed that the augmented PSD in each frequency bin is higher than its counterpart in the reference PSD because augmentation is an additive process and the speech and non-speech signals are presumed to be uncorrelated.

At block 720, the amount of loss necessary to apply to each augmented PSD may be determined to make it match the reference PSD. This may be simply the difference between the Augmented Power minus the Reference Power for each frequency bin. Subtraction may be the correct operation because the PSD is in log (dB) scale. The losses may be limited to be within a range of 0 to M dB. At the low end, 0 dB may be used for the case where there may be some short-term correlation between the reference and augmented signals. The M dB may be used at the high end to avoid overly aggressive noise reduction.

The current frame's input features may be extracted and combined with the features from the past N frames at block 722. The extracted and combined input features may be stored as the first column (features) in the labelled data table at block 724. The 256 TF losses 726 may be stored in the second column. In this example, with respect to the frame size, subband analysis may input 256 PCM samples at a time and forms 256 TF samples 726, hence the PCM frame size may be 256 samples.

Once the labelled data are determined at block 724, a machine learning model may be trained with the labelled data to predict the optimum TF losses for previously unknown input audio as a function of current and past input features. Previously unknown input audio may indicate the audio that was not used in the training process. It should be noted that estimation of TF losses in this manner may not always yield the best voice quality as signal to noise ratio may not be the best measure of voice quality.

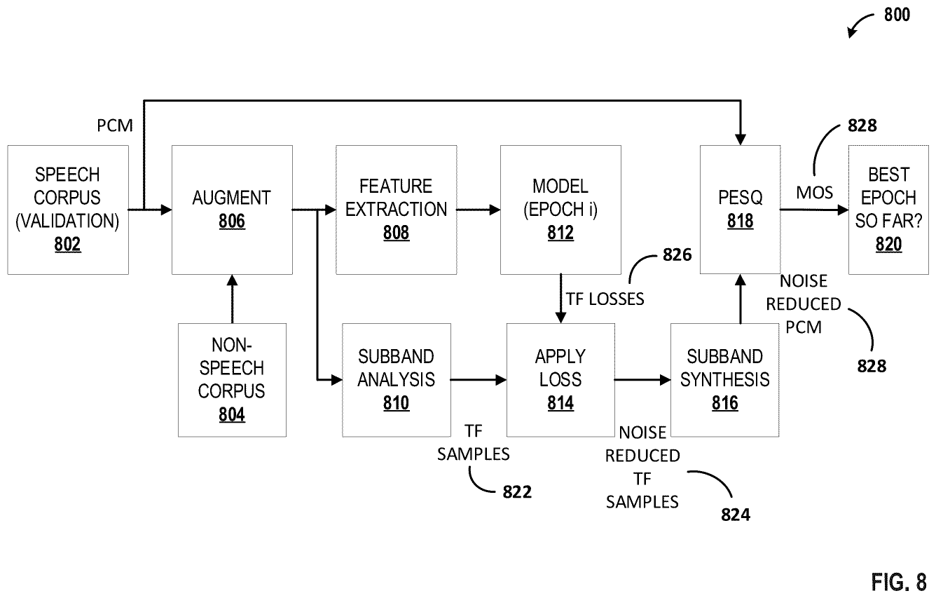

FIG. 8 shows an example training process 800 for noise reduction. The training process 800 may be performed in steps or epochs. Typically at the end of the epoch, there may be a check to determine if the model created during the epoch is better than the previous best model by running a validation data set through the model and computing the cost function. Validation data may be a set of speech samples that are not included in the training data. The cost function for the training model up to this point (or the current epoch) may be error in determined TF losses versus the labelled TF losses. Using the training process 800, the cost using Perceptual Evaluation of Speech Quality (PESQ) may be determined. The PESQ may be a direct estimate of the speech quality of the noise-reduced audio.

The training process 800 may start with a validation speech corpus and a non-speech corpus at blocks 802, 804. The validation speech corpus may be a set of audio files that includes speech only. The non-speech corpus may be a set of audio files that includes sounds that do not include speech but include the types of interference to be removed. The types of interference to be removed may comprise stationary noise and non-stationary noise. Examples of the non-stationary noise may include, but are not limited to, a dog barking, keyboard clicking, a baby crying, music, traffic, wind, reverberation, and background conversation. The reverberation may refer to one or more impairments in the audio files. At block 806, the validation speech corpus may be augmented by the non-speech corpus. At block 808, one or more features from the augmented speech may be extracted. At block 812, the model from the current epoch may be used to determine the TF losses 826. At block 810, subband analysis may be performed on the augmented speech to produce TF samples 822. At block 814, the TF losses 826 may be applied to the TF samples 822. The resulting noise-reduced TF samples 824 may be sent to the subband synthesis at block 816 to convert to noise reduced PCM 828.

At block 818, PESQ may be determined based on the noise reduced PCM 828 and the original speech. The PESQ may estimate the speech quality of the noise reduced signal in units of mean opinion score (MOS). The average MOS 830 may be determined across the validation set to form the overall score for this epoch's model. At block 820, if this model's score is better than the previous best model, the new model may become the best and its score may be saved for comparison purposes in subsequent epochs.

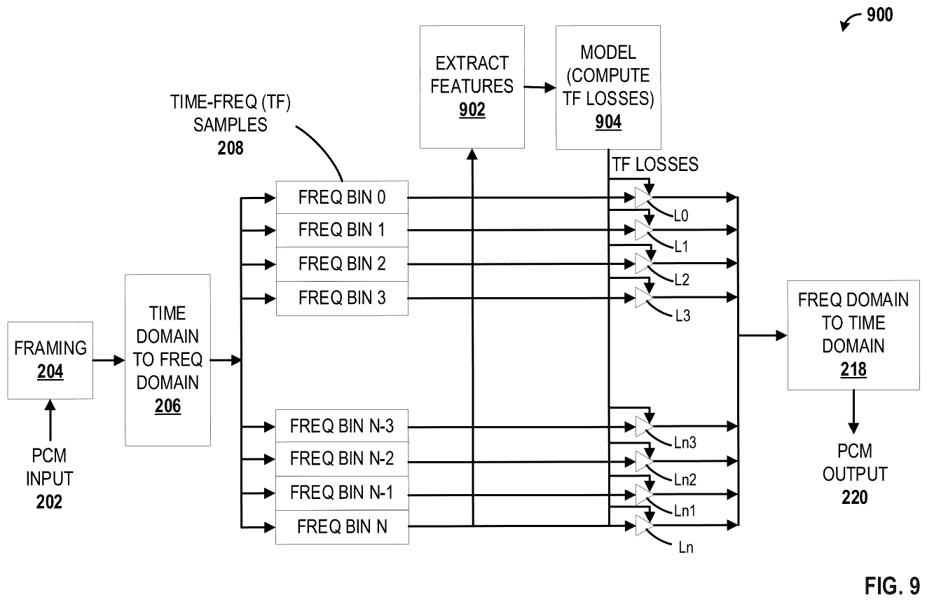

FIG. 9 shows an example method 900 for noise reduction with the ML model-estimated TF losses. The blocks and signals 202-208 and 218-220 shown in FIG. 9 are the same as or substantially similar to those shown in FIG. 2 and are not described herein for brevity. At block 902, one or more features may be extracted from TF samples 208. At block 904, using the selected machine learning model in FIG. 8, the machine learning model may directly determine the TF losses that are applied to each frequency bin on a per-frame basis. At block 218, the noise-reduced TF samples may be sent to a frequency-to-time domain converter. At block 220, the noise reduced PCM time domain sample stream may be generated.

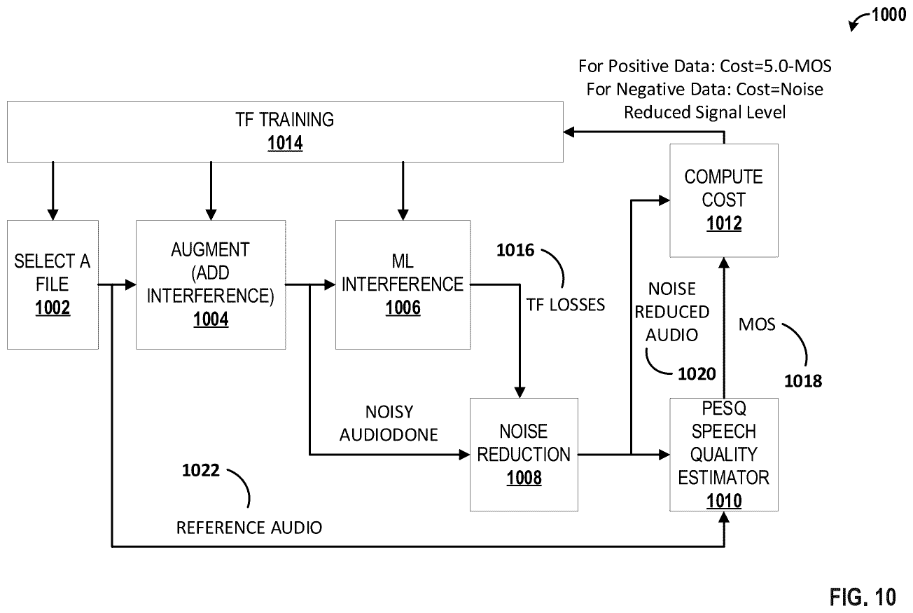

FIG. 10 shows an example training process 1000 for noise reduction. Similar to the training process 800 in FIG. 8, the training process 1000 may use the PESQ speech quality estimate as the cost function during the entire training loop rather than only at the end of each epoch. By using the PESQ speech quality estimate during the entire training loop, a machine learning model that maximizes speech quality may be obtained. FIG. 10 shows show a higher level of the training process 1000 including the cost function and how it feeds back into TF training block 1014 which monitors epoch cost and iteratively adjusts the machine leaning model from epoch to epoch accordingly. However, the PESQ speech quality estimate in FIG. 10 may be still used on a per-epoch basis as described in FIG. 8. For example, FIG. 8 shows more detail on a per-epoch basis.

The training process 1000 may start with a clean speech corpus (or speech files) and a non-speech corpus (or non-speech files) at blocks 1002. The audio files (e.g., the speech file) may be augmented by adding various types of non-speech interference at block 1004. Augmentation may include reverberation, pitch shift, tempo shift, and/or the like. In the case of the pitch shift or tempo shift, those augmentations may be determined before the other augmentation and the output of the pitch shift and/or tempo shift may be used as the reference audio. At block 1006, the machine learning model may be trained to learn an optimum set of TF losses 1016 to apply to a noise reduction at block 1008 similar to the noise reduction shown in FIG. 2.

Specifically, at each stage of training, the TF losses 1016 may be applied to a set of augmented audio samples. For augmented audio that is primarily speech, the cost function that drives the training of the inference model may be the mean opinion score 1018 (from the PESQ block 1010) of the noise-reduced output 1020. For augmented audio that is primarily non-speech, the cost may represent the signal level of the noise-reduced speech normalized to the same range of the MOS-based cost. In this case, the noise-reduced signal level may be used as the cost because the goal in noise reduction when a non-speech input is present is to drive the output to zero.

For augmented audio that is primarily speech, at block 1010, PESQ may be determined for each resulting noise-reduced audio file 1020 along with the associated clean speech file (e.g., reference audio 1022). At block 1010, the mean opinion score (MOS) 1018 of perceived speech quality may be determined. The MOS 1018 may be within the range of 1 (bad) to 5 (excellent). At block 10120, a cost may be determined based on the MOS scores 1018 of the set of augmented speech files. For example, the cost function may be cost=5−MOS, which determines the overall cost that is sent back to the training at block 1014. For augmented audio that is primarily non-speech, the PESQ may not be needed to determine the cost. The signal level of the noise reduced audio 1020 may be used as the cost. With each successive pass, the training model may modify the model parameters in such a way to reduce the cost.

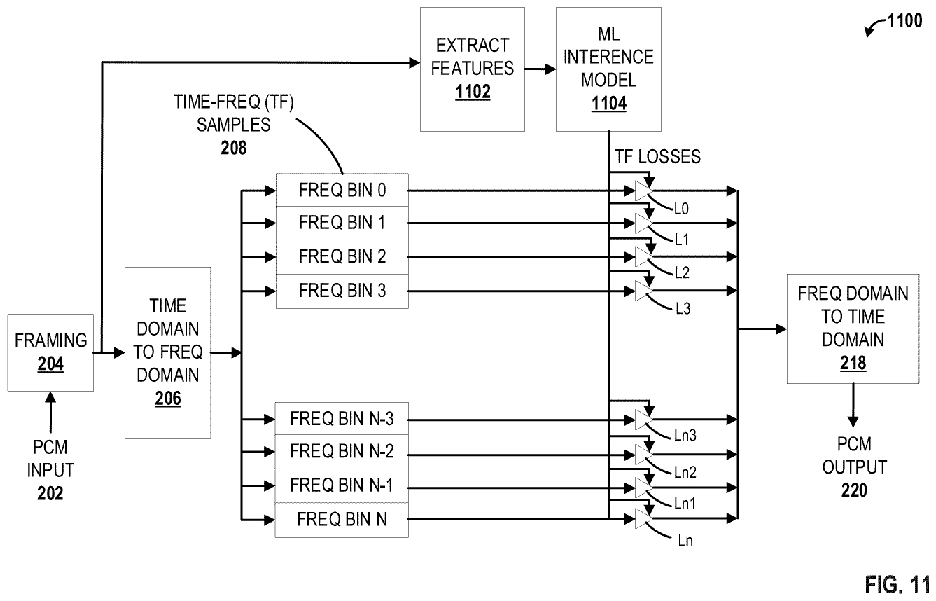

FIG. 11 shows an example method 1100 for noise reduction with a machine learning model-inferenced TF losses. The blocks and signals 202-208 and 218-220 shown in FIG. 11 are the same as or substantially similar to those shown in FIG. 2 and are not described herein for brevity. At block 1102, one or more features may be extracted from one or more frames. For example, a continuous stream of the input signal 202 (e.g., PCM-coded samples) may be divided into discrete segments or frames. Each frame may comprise a fixed number of PCM samples and may be 10 to 20 milliseconds long. At block 1104, based on the extracted features, the machine learning model may determine the TF losses that are applied to each frequency bin on a per-frame basis. At block 218, the noise-reduced TF samples may be sent to a frequency-to-time domain converter. At block 220, the noise reduced PCM time domain sample stream may be generated.

The machine learning model that is used for speech recognition may use Mel Frequency Cepstral Coefficients (MFCCs) as input features. In this case, the Cepstrum may not be used because in the process of converting from Mel Frequency Spectrum to MFCC, some detailed spectral information that is useful in computing the TF losses may be lost. It is because MFCCs represent the shape of the spectrum or the spectrum of the spectrum. The Mel spectrum itself may retain spectral information but does so using logarithmic frequency spacing rather than uniform spacing, which is the case for an FFT or subband analysis. When using the Mel spectrum, the machine learning model may inherently need to map the Mel frequency spacing into the uniform spacing.

Alternately or additionally, a full set of TF samples may be used as the input features. That may prove to be less effective at discerning between speech and interference, and it may increase the model size significantly and hence require more CPU resources to implement the inference model (or the machine learning model).

Although not shown in FIG. 11, the feature extraction can take the TF samples as input rather than using the raw PCM as input. The Mel frequency spectrum may be derived from the amplitudes of the TF samples by applying triangular weighting to the amplitudes of the frequency bins.

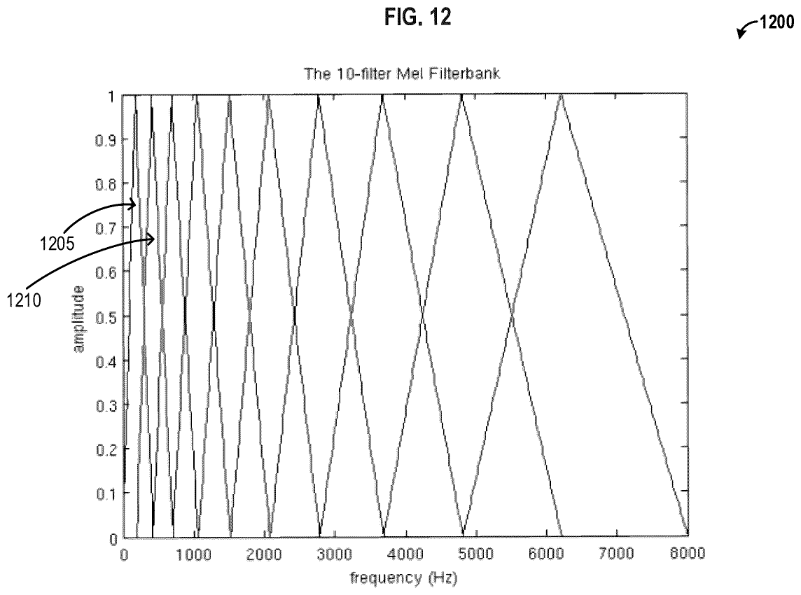

FIG. 12 shows an example diagram 1200 for the Mel-spaced frequency bins and the overlapping triangular windows that can be used to convert between TF amplitudes and Mel frequency spectrum. The first triangular window 1205 may apply across the first few TF amplitudes. The next window 1210 may apply to a portion of the first set of TF amplitudes and continue to the next few. Each subsequent triangular window may cover an increasing bandwidth and therefore an increasing number of TF amplitudes.

Alternatively or additionally, the inference model or the machine learning model (e.g., shown in FIG. 11) may determine the optimum losses on a per-Mel band basis rather than on a per-frequency-bin basis. In this case, the noise reduction may apply each Mel band's loss to the frequency bins that lie primarily within the Mel band. The term primarily may refer to the frequency bin falls between the two overlap crossovers of a Mel band.

Turning now to FIG. 13, an example system 1300 for machine learning model training is shown. The system 1300 may be configured to use machine learning techniques to train, based on an analysis of a plurality of training datasets 1310A-1310B by a training module 1320, a classification/prediction model 1330. Functions of the system 1300 described herein may be performed, for example, by the user device 101 and the computing device 111, and/or another computing device in communication with the computing device 111 and/or the user device 101. The plurality of training datasets 1310A-1310B may be associated with input data or annotated data described herein. For example, the training dataset 1310A may comprise one or more labelled data (e.g., labelled data 1-N). Each of the one more labelled data in the training dataset 1310A may comprise one or more inputs (e.g., input features) and corresponding known outputs associated with the one or more inputs. For example, labelled data 1 of the training dataset 1310A may comprise one or more input features (e.g., MFCCs) and one or more indications or labels indicating whether speech is present or not. For example, labelled data 1 of the training data set 1310A may comprise one or more input features and one or more TF losses associated with the one or more input features.

Similarly, the training dataset 1310B may comprise one or more labelled data (e.g., labelled data 1-N). Each of the one more labelled data in the training dataset 1310B may comprise one or more inputs (e.g., input features) and corresponding known outputs associated with the inputs. For example, labelled data 1 of the training data set 1310B may comprise one or more input features (e.g., MFCCs) and one or more indications or labels indicating whether speech is present or not. For example, labelled data 1 of the training data set 1310B may comprise one or more input features and one or more TF losses associated with the one or more input features.

The training datasets 1310A, 1310B may be based on, or comprise, the data stored in database of the user device 101 or the computing device 111. Such data may be randomly assigned to the training dataset 1310A, the training dataset 1310B, and/or to a testing dataset. In some implementations, assignment may not be completely random and one or more criteria or methods may be used during the assignment. For example, the training dataset 1310A and/or the training dataset 1310B may be generated from speech corpus and non-speech corpus as described in FIGS. 5, 7, 15, and 16. The speech corpus may be a set of audio files that include speech only. The non-speech corpus may be a set of audio files that includes sounds that do not include speech but include one or more types of interference to be removed. The one or more types of interference to be removed may comprise stationary noise and non-stationary noise. Examples of the non-stationary noise may include, but are not limited to, a dog barking, keyboard clicking, a baby crying, music, traffic, wind, reverberation, and background conversation. In general, any suitable method may be used to assign the data to the training and/or testing datasets.

The training module 1320 may train the classification/prediction model 1330 by determining/extracting the features from the training dataset 1310A and/or the training dataset 1310B in a variety of ways. For example, the training module 1320 may determine/extract a feature set from the training dataset 1310A and/or the training dataset 1310B to estimate a speech probability as described in FIGS. 5, 6, and 15. The training module 1320 may determine/extract a feature set from the training dataset 1310A and/or the training dataset 1310B to determine one or more optimum TF losses as described in FIGS. 7, 8, 9 and 16. The training module 1320 may use the feature sets to generate classification/prediction models 1340A-1340N for classification of speech or non-speech and/or for optimum TF loss.

The training dataset 1310A and/or the training dataset 1310B may be analyzed to determine any dependencies, associations, and/or correlations between features in the training dataset 1310A and/or the training dataset 1310B. The identified correlations may have the form of a list of features that are associated with different labeled predictions. The term “feature,” as used herein, may refer to any characteristic of an item of data that may be used to determine whether the item of data falls within one or more specific categories or within a range. A feature selection technique may comprise one or more feature selection rules. The one or more feature selection rules may comprise a feature occurrence rule. The feature occurrence rule may comprise determining which features in the training dataset 1310A occur over a threshold number of times and identifying those features that satisfy the threshold as candidate features. For example, any features that appear greater than or equal to 5 times in the training dataset 1310A may be considered as candidate features. Any features appearing less than 5 times may be excluded from consideration as a feature. Other threshold numbers may be used as well.

A single feature selection rule may be applied to select features or multiple feature selection rules may be applied to select features. The feature selection rules may be applied in a cascading fashion, with the feature selection rules being applied in a specific order and applied to the results of the previous rule. For example, the feature occurrence rule may be applied to the training dataset 1310A to generate a first list of features. A final list of candidate features may be analyzed according to additional feature selection techniques to determine one or more candidate feature groups (e.g., groups of features that may be used to determine a prediction). Any suitable computational technique may be used to identify the candidate feature groups using any feature selection technique such as filter, wrapper, and/or embedded methods. One or more candidate feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms used by the system 1300. Instead, features may be selected on the basis of scores in various statistical tests for their correlation with the outcome variable (e.g., a prediction).

As another example, one or more candidate feature groups may be selected according to a wrapper method. A wrapper method may be configured to use a subset of features and train the prediction model 1330 using the subset of features. Based on the inferences that may be drawn from a previous model, features may be added and/or deleted from the subset. Wrapper methods include, for example, forward feature selection, backward feature elimination, recursive feature elimination, combinations thereof, and the like. For example, forward feature selection may be used to identify one or more candidate feature groups. Forward feature selection is an iterative method that begins with no features. In each iteration, the feature which best improves the model is added until an addition of a new variable does not improve the performance of the model. As another example, backward elimination may be used to identify one or more candidate feature groups. Backward elimination is an iterative method that begins with all features in the model. In each iteration, the least significant feature is removed until no improvement is observed on removal of features. Recursive feature elimination may be used to identify one or more candidate feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the training module 1320 has generated a feature set(s), the training module 1320 may generate the classification/prediction models 1340A-1340N based on the feature set(s). A machine learning-based classification/prediction model (e.g., any of the classification/prediction models 1340A-1340N) may refer to a complex mathematical model for the classification of speech or non-speech and/or for the prediction of optimum TF loss. The complex mathematical model for the classification of speech or non-speech and/or for the prediction of optimum TF loss may be generated using machine-learning techniques as described herein. In one example, a machine learning-based classification model may determine a speech probability estimate that distinguishes speech from stationary noise and/or non-stationary noise. In another example, a machine learning-based prediction model may predict optimum TF loss to be applied to one or more TF samples for noise reduction. By way of example, boundary features may be selected from, and/or represent the highest-ranked features in, a feature set. The training module 1320 may use the feature sets extracted from the training dataset 1310A and/or the training dataset 1310B to build the classification/prediction models 1340A-1340N for the classification of speech or non-speech and the optimum TF loss to be applied for noise reduction. In some examples, the classification/prediction models 1340A-1340N may be combined into a single classification/prediction model 1340 (e.g., an ensemble model). Similarly, the classification/prediction model 1330 may represent a single model containing a single or a plurality of classification/prediction models 1340 and/or multiple models containing a single or a plurality of classification/prediction models 1340 (e.g., an ensemble model). It is noted that the training module 1320 may be part of the audio analysis component 102 of the user device 101 and/or the audio analysis component 112 of the computing device 111.

The extracted features (e.g., one or more candidate features) may be combined in the classification/prediction models 1340A-1340N that are trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting classification model 1330 may comprise a decision rule or a mapping for each candidate feature in order to assign a prediction to a class.

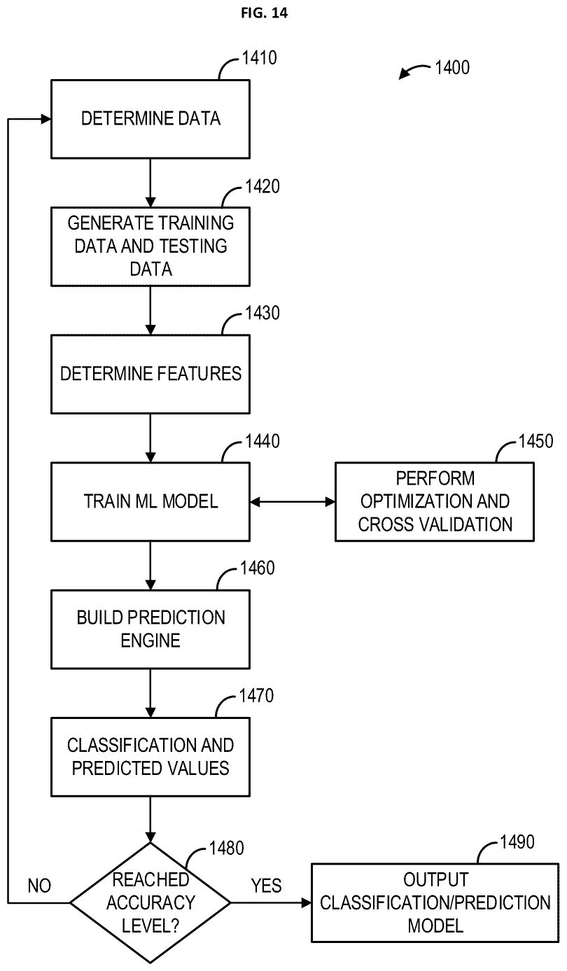

FIG. 14 is a flowchart illustrating an example training method 1400 for generating the classification/prediction model 1330 using the training module 1320. The training module 1320 may implement supervised, unsupervised, and/or semi-supervised (e.g., reinforcement based) learning. The method 1400 illustrated in FIG. 14 is an example of a supervised learning method; variations of this example of training method may be analogously implemented to train unsupervised and/or semi-supervised machine learning models. The method 1400 may be implemented by any of the devices shown in any of the systems 100, or 1600. For example, the method 1400 may be part of the audio analysis component 102 of the user device 101 and/or the audio analysis component 112 of the computing device 111.

At step 1410, the training method 1400 may determine (e.g., access, receive, retrieve, etc.) first training data and second training data (e.g., the training datasets 1310A-1310B). The first training data and the second training data may each comprise one or more labelled data. The one more labelled data may comprise one or more inputs (e.g., input features) and corresponding known outputs associated with the one or more inputs. In one example, the one or more labelled data may comprise one or more input features (e.g., MFCCs) and one or more indications or labels indicating whether speech is present or not. In another example, the one or more labelled data may comprise one or more input features and one or more TF losses associated with the one or more input features. The training method 1400 may generate, at step 1420, a training dataset and a testing dataset. The training dataset and the testing dataset may be generated by randomly assigning data from the first training data and/or the second training data to either the training dataset or the testing dataset. In some implementations, the assignment of data as training or test data may not be completely random. As an example, the first training dataset and/or the second training dataset may be generated from speech corpus and non-speech corpus as described in FIGS. 5, 7, 15, and 16. The speech corpus may be a set of audio files that include speech only. The non-speech corpus may be a set of audio files that includes sounds that do not include speech but include one or more types of interference to be removed. The one or more types of interference to be removed may comprise stationary noise and non-stationary noise. Examples of the non-stationary noise may include, but are not limited to, a dog barking, keyboard clicking, a baby crying, music, traffic, wind, and background conversation.

The training method 1400 may determine (e.g., extract, select, etc.), at step 1430, one or more features that may be used for, for example, classification of speech or non-speech and/or prediction of optimum TF loss. The one or more features may comprise a set of features. As an example, the training method 1400 may determine a set of features from the first training data. As another example, the training method 1400 may determine a set of features from the second training data.

The training method 1400 may train one or more machine learning models (e.g., one or more classification models, one or more prediction models, neural networks, deep-learning models, etc.) using the one or more features at step 1440. In one example, the machine learning models may be trained using supervised learning. In another example, other machine learning techniques may be used, including unsupervised learning and semi-supervised. The machine learning models trained at step 1440 may be selected based on different criteria depending on the problem to be solved and/or data available in the training dataset. For example, machine learning models may suffer from different degrees of bias. Accordingly, more than one machine learning model may be trained at 1440, and then optimized, improved, and cross-validated at step 1450.

The training method 1400 may select one or more machine learning models to build the classification/prediction model 1330 at step 1460. The classification/prediction model 1330 may be evaluated using the testing dataset. The classification/prediction model 1330 may analyze the testing dataset and generate classification values (e.g., values indicating speech or non-speech) and/or predicted values (e.g., optimum TF loss predictions) at step 1470. Classification and/or prediction values may be evaluated at step 1480 to determine whether such values have achieved a desired accuracy level. Performance of the classification/prediction model 1330 may be evaluated in a number of ways based on a number of true positives, false positives, true negatives, and/or false negatives classifications of the plurality of data points indicated by the classification/prediction model 1330. For example, PESQ estimates or MOS scores may be used to evaluate the performance of the classification/prediction model 1330. Specifically, the PESQ estimates or the MOS produced by the classification/prediction model 1340A during a current epoch may be compared to a previous PESQ estimate(s) or MOS produced by the classification/prediction model 1340N during a previous epoch. Related to these measurements are the concepts of recall and precision. Generally, recall refers to a ratio of true positives to a sum of true positives and false negatives, which quantifies a sensitivity of the classification/prediction model 1330. Similarly, precision refers to a ratio of true positives a sum of true and false positives. When such a desired accuracy level is reached, the training phase ends and the classification/prediction model 1330 may be output at step 1490; when the desired accuracy level is not reached, however, then a subsequent iteration of the training method 1400 may be performed starting at step 1410 with variations such as, for example, considering a larger collection of labelled data from speech corpus and non-speech corpus. The classification/prediction model 1330 may be output at step 1490.

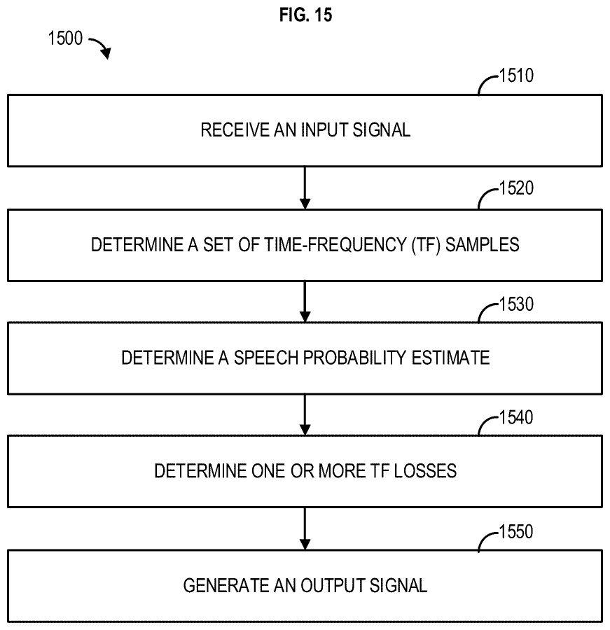

FIG. 15 shows an example method 1500 for noise reduction. The method 1500 may be performed by any device, such as a user device 101 or a computing device 111. At step 1510, an input signal may be received. For example, the computing device 111 may receive an input signal that comprises speech and non-speech. The input signal may be a pulse code modulation (PCM) signal. The non-speech may comprise stationary noise and non-stationary noise. The non-stationary noise may refer to a type of noise that does not have a constant statistical distribution or properties over time. In other words, its characteristics, such as amplitude, frequency, or spectral composition, may change with time. Examples of the non-stationary noise may include, but are not limited to, a dog barking, keyboard clicking, a baby crying, music, traffic, wind, and background conversation. The user device 101 or the computing device 111 may be a smart TV, an interactive camera, a set-top box, or a voice enabled remote controller.

At step 1520, a set of time-frequency samples may be determined. For example, a computing device 111 may convert the input signal (e.g., time domain signal) to a set of time-frequency (TF) samples (e.g., frequency domain signals). Specifically, each frame of the input signal may be converted to the frequency domain signals using techniques such as subband encoding, Fast Fourier Transform, or the like. Each time-frequency sample may comprise a frequency bin narrowly filtered based on a frequency domain. For example, if the frame size is 256 samples and the sampling rate is 16 kHz, a subband encoder may output 256 time-frequency (TF) samples. Each TF sample may represent a narrow frequency bin whose width is 31.25 Hz.

At step 1530, a speech probability estimate may be determined. For example, the computing device 111 may determine the speech probability estimate for each TF sample. The computing device 111 may determine the speech probability estimate for each TF sample based on the set of TF samples. The speech probability estimate for the each TF sample (of the set of TF samples) may indicate that the speech is present in each TF sample (of the set of TF samples). The speech probability estimate may further distinguish the speech from the stationary noise and the non-stationary noise. The speech probability estimate may be provided by a machine learning model (e.g., the classification/prediction model 1330) based on a labelled data set. The labelled data set may comprise one or more input features and one or more indications indicating whether speech is present or not. The user device 101 or the computing device 111 may implement the machine learning model.

In order to generate the labelled data set, a set of speech samples (or speech corpus) and a set of non-speech samples (or non-speech corpus) may first be received. Examples of speech corpus may include, but are not limited to, podcast speech, radio speech, TV conversation, and voice audio. Examples of non-speech corpus may include, but are not limited to, a dog barking, a baby crying, keyboard clicking, and stationary noise. Once the set of speech samples is received, a speech weight may be applied to the each of the set of speech samples. Once the set of non-speech samples is received, a non-speech weight may be applied to the each of the set of non-speech samples. For example, if there is a clean speech sample, a weight of one (1) may be applied to the clean speech sample. If there is a purely non-speech sample, a weight of zero (0) may be applied to the non-speech sample. If there is a noisy speech sample, a weight of one (1) may be applied to the speech portion of the noisy speech sample and a weight of 0.1 may be applied to the non-speech portion of the noise speech sample.

The weights for the purpose of training a machine learning model may be determined by various ways In an example, when noise to speech is added, the value of every TF sample associated with the clean speech may be computed at every point in time. The TF sample for the speech plus noise may also be computed at every point in time. By way of example, the speech TF sample for frequency bin B and time frame T may be defined as TFS[B][T]. Similarly, the speech TF sample for frequency bin B plus noise may be defined as TFSN[B][T]. Using a weight of TFW[B][T]=TFS[B][T]/TFSN[B][T], to TFSN[B][T], a weight of TFS[B][T] may be obtained. In another example, machine learning may determine the weights. Specifically, if the method using the MOS in the cost function is used in training a machine leaning model, the TF weights may not be computed prior to the training. The machine learning model may learn by itself how to predict the TF weights in such a way that mean opinion score(s) are optimized.

The speech weighted set of speech samples and the non-speech weighted set of non-speech samples may be combined to generate a speech augmented set. One or more features may be extracted from the speech augmented set. The one or more extracted features may be Mel Frequency Cepstrum Coefficients (MFCCs), Phonemes, Senones, and/or Mel Spectrogram. The one or more extracted features may be stored in the labelled data as the input features.

In addition, based on the speech weighted set of speech samples and the non-speech weighted set of non-speech samples, the one or more indications or labels indicating whether speech is present may be determined. The one or more indications or labels may also be stored in the labelled data. For example, if the speech weight is greater than the non-speech weight, a one (1) may be labelled. However, if the non-speech weight is greater than the speech weight, a zero may be labelled because the signal is so unintelligible that the desired signal cannot be extracted. The label 1 may indicate that speech is present or predominant. The label 0 may indicate that non-speech is present or predominant.

The labelled data set may be provided to the machine learning model to determine the speech probability estimate. The value of the speech probability estimate may be between 0.0 and 1.0. The value between 0.1 and 1.0 may indicate the probability that the current signal includes speech or non-speech. For example, the higher value may indicate that the current signal likely includes human speech and the lower value may indicate that the current signal likely includes non-speech and/or interference.

At step 1540, one or more TF losses may be determined. For example, the computing device 111 may determine one or more TF losses to be applied to one or more TF samples of the set of TF samples. The computing device 111 may determine the one or more TF losses to be applied based on the speech probability estimate for each TF sample of the set of TF samples. The computing device 111 may apply the TF losses to each frequency bin on a per-frame basis. For example, based on the speech probability estimate, little to no loss may be applied to frequency bins that are deemed not to be noise. More loss may be applied to frequency bins that are deemed to be noise based on the speech probability estimate. Additionally or alternatively, the TF losses may be determined based on the current a-priori SNR (e.g., at block 210) and the previous a-posteriori SNR (e.g., at block 216).

At step 1550, an output signal may be generated. For example, the computing device 111 may provide the noise-reduced TF samples to a frequency-to-time domain converter. The noise-reduced TF samples (e.g., frequency domain signals) may be converted to time domain signals, for example, using subband synthesis, inverse FFT, and/or inverse wavelet transform, to generate the PCM output signal (e.g., noise reduced PCM sample stream).

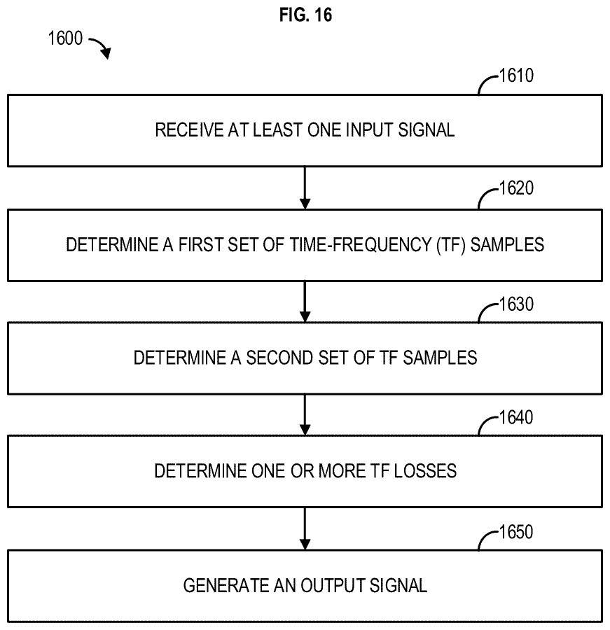

FIG. 16 shows an example method 1600 for generating labelled data for noise reduction. The method 1600 may be performed by any devices such as a user device 101 or a computing device 111. At step 1610, at least one input signal may be received. For example, the computing device 101 may receive at least one input signal that comprises a set of speech signals and a set of non-speech signals. The set of speech signals may be referred to as a speech corpus. The speech corpus may be a set of audio files that include speech only. Examples of speech corpus may include, but are not limited to, podcast speech, radio speech, TV conversation, and voice audio. The set of non-speech signals may be referred to as a non-speech corpus. The non-speech corpus may be a set of audio files that includes sounds that do not include speech but include the types of interference to be removed. Examples of non-speech corpus may include, but are not limited to, a dog barking, a baby crying, keyboard clicking, reverberation, and stationary noise. The set of non-speech signals may comprise stationary noise and non-stationary noise.

At step 1620, a first set of time-frequency (TF) samples may be determined. The first set of TF samples may be determined based on the set of speech signals. For example, the computing device 111 may apply a speech weight to each speech signal of the set of speech signals. The computing device 111 may convert the weighted speech signals to a first set of TF samples using subband analysis (or FFT). Each of the first set of TF samples may comprise a frequency bin narrowly filtered based on a frequency domain.

At step 1630, a second set of TF samples may be determined. The second set of TF samples may be determined based on a set of augmented signals. The set of augmented signals may be determined based on the set of speech signals and the set of non-speech signals. For example, the computing device 111 may apply a non-speech weight to each non-speech signal of the set of non-speech signals. The computing device 111 may combine the set of non-speech signals with the set of speech signals to generate a set of augmented signals. The computing device 111 may convert the set of augmented signals to a second set of TF samples using subband analysis (or FFT). Each of the second set of TF samples may comprise a frequency bin narrowly filtered based on the frequency domain.

At step 1640, one or more TF losses may be determined. The one or more TF losses may be determined based on the first set of TF samples and/or the second set of TF samples. For example, the computing device 111 may determine a reference power spectral density (PSD). The computing device 111 may determine the reference PSD based on the first set of TF samples. The computing device 111 may use Log Power Spectrum to determine the reference PSD from the first set of TF samples. The reference PSD may indicate the distribution of power of the first set of TF samples. Similarly, the computing device 111 may determine an augmented PSD. For example, the computing device 111 may determine the augmented PSD based on the second set of TF samples. The computing device 111 may use Log Power Spectrum to determine the augmented PSD from the second set of TF samples. The augmented PSD may indicate the distribution of power of the second set of TF samples.

The computing device 111 may determine the one or more TF losses. For example, computing device 111 may determine the one or more TF losses based on the reference PSD and the augmented PSD. The one or more TF losses may indicate one or more differences between the reference PSD and the augmented PSD. The one or more TF losses may be stored in a labelled data set for machine learning. The labelled data set may comprise one or more input features and the one or more TF losses. The one or more input features may be extracted from one or more frames associated with the augmented PSD. The labelled data set may be provided to a machine learning model (e.g., the classification/prediction model 1330) configured to further determine the one or more TF losses. The one or more TF losses determined by the machine learning model (e.g., the classification/prediction model 1330) may be applied to one or more TF samples associated with the at least one input signal to generate one or more noise-reduced TF samples. The computing device 111, the user device 101, or a server may implement the machine learning model.

The machine learning model (e.g., the classification/prediction model 1330) may be selected from a plurality of machine learning models (e.g., the classification/prediction models 1340A, N) based on the cost function. For example, there may be a check to determine if the machine learning model created during the epoch is better than the previous best matching learning model by running a validation data set through the model and computing the cost function. Specifically, a TF losses produced by a machine learning model (e.g., the classification/prediction models 1340N) during the current epoch may be compared with a previous TF loss produced by another machine learning model (e.g., the classification/prediction models 1340A) during the previous epoch to determine the best machine learning model. The machine learning model (e.g., the classification/prediction model 1330) may be selected based on a set of validated speech signals (e.g., validation speech corpus) and a set of non-speech signals (e.g., non-speech corpus) using a Perceptual Evaluation of Speech Quality (PESQ) estimate iterated for each of the plurality of epochs. The PESQ may be a direct estimate of the speech quality of the noise-reduced audio.

At step 1650, an output signal may be generated. For example, the computing device 111 may apply the one or more TF losses to one or more TF samples associated with the at least one input signal to generate one or more noise reduced TF samples. Little to none TF loss may be applied to the TF samples that are deemed not to be noise. More TF loss may be applied to TF samples that are deemed to be noise. The one or more TF losses may be provided by the selected machine learning model. The one or more noise-reduced TF samples may then be sent to a frequency-to-time domain converter to generate the output signal. The output signal may comprise less non-speech than the at least one input signal.

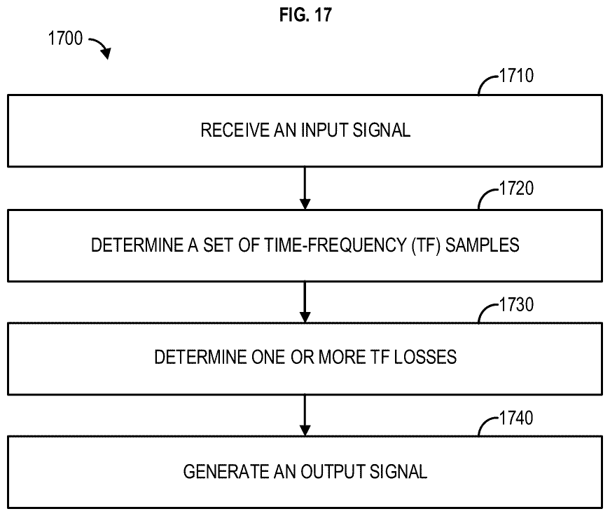

FIG. 17 shows an example method 1700 for generating labelled data for noise reduction. The method 1700 may be performed by any devices such as a user device 101 or a computing device 111. At step 1710, an input signal may be received. For example, the computing device 111 may receive an input signal that comprises speech and non-speech. The input signal may be a pulse code modulation (PCM) signal. The non-speech may comprise stationary noise and non-stationary noise. Examples of the non-stationary noise may include, but are not limited to, a dog barking, keyboard clicking, a baby crying, music, traffic, wind, and background conversation. The user device 101 or the computing device 111 may be a smart TV, an interactive camera, a set-top box, or a voice enabled remote controller.

At step 1720, a set of time-frequency samples may be determined. For example, a computing device 111 may convert the input signal (e.g., time domain signal) to a set of time-frequency (TF) samples (e.g., frequency domain signals). Specifically, each frame of the input signal may be converted to the frequency domain signals using techniques such as subband encoding, Fast Fourier Transform, or the like. Each time-frequency sample may comprise a frequency bin narrowly filtered based on a frequency domain.

At step 1730, one or more TF losses may be determined. For example, the computing device 111 may determine one or more TF losses to be applied to one or more TF samples of the set of TF samples. The computing device 111 may determine the one or more TF losses to be applied based on one or more speech quality scores. For example, in order to determine the one or more speech quality scores, a set of speech samples (or speech corpus) and a set of non-speech samples (or non-speech corpus) may first be received. Examples of speech corpus may include, but are not limited to, podcast speech, radio speech, TV conversation, and voice audio. Examples of non-speech corpus may include, but are not limited to, a dog barking, a baby crying, keyboard clicking, and stationary noise.

The set of speech signals and the set of non-speech signals may be augmented with various types of non-speech interferences to generate a set of augmented signals. Examples of the non-speech interferences may include, but are not limited to, a reverberation, a pitch shift, and a tempo shift. The set of augmented signals may be provided to a machine learning model (e.g., the classification/prediction model 1330) determine the one or more TF losses. The machine learning inferenced TF losses may be applied to the set of augmented signals to generate a set of non-speech reduced signals. Specifically, the one or more TF losses may be applied to the set of augmented signals at each stage of training. The one or more speech quality scores may be determined based on the set of non-speech reduced signals. The one or more speech quality scores may be one or more mean opinion scores (MOSs) determined by the PESQ analyzer. Each speech quality score may range from 1 (bad) to 5 (excellent). The one or more speech quality scores may be sent to the cost function. The overall cost determined by the cost function may be sent to the machine learning model (e.g., the classification/prediction models 1330) to determine the one or more TF losses.

At step 1740, an output signal may be generated. For example, the computing device 111 may apply the one or more TF losses to one or more TF samples of the set of TF samples to generate one or more noise reduced TF samples. Little to no TF loss may be applied to the TF samples that are deemed not to be noise. More TF loss may be applied to TF samples that are deemed to be noise. The one or more TF losses may be provided by the machine learning model (e.g., the classification/prediction models 1330) trained with the PESQ estimates. The one or more noise-reduced TF samples may then be sent to a frequency-to-time domain converter to generate the output signal. The output signal may comprise less non-speech than the at least one input signal.

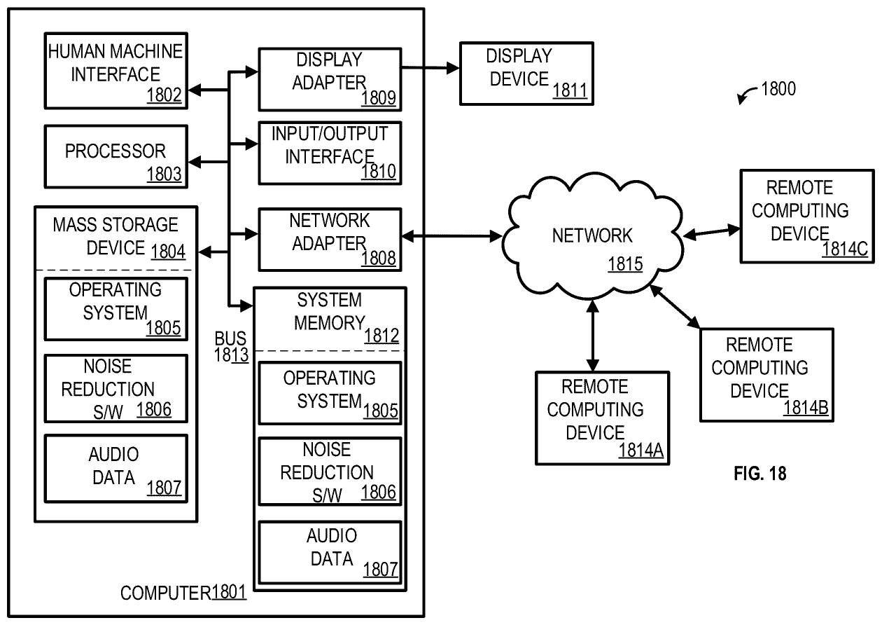

FIG. 18 shows an example system 1800 for noise reduction. The user device 101 and/or the computing device 111 of FIG. 1 may be a computer 1801 as shown in FIG. 18. The computer 1801 may include one or more processors 1803, a system memory 1812, and a bus 1813 that couples various system components including the one or more processors 1803 to the system memory 1812. In the case of multiple processors 1803, the computer 1801 may utilize parallel computing. The bus 1813 is one or more of several possible types of bus structures, including a memory bus or memory controller, a peripheral bus, an accelerated graphics port, or local bus using any of a variety of bus architectures.

The computer 1801 may operate on and/or include a variety of computer readable media (e.g., non-transitory). The readable media may be any available media that is accessible by the computer 1801 and may include both volatile and non-volatile media, removable and non-removable media. The system memory 1812 has computer readable media in the form of volatile memory, such as random access memory (RAM), and/or non-volatile memory, such as read only memory (ROM). The system memory 1812 may store data such as the audio data 1807 and/or program modules such as the operating system 1805 and the noise reduction software 1806 that are accessible to and/or are operated on by the one or more processors 1803.

The computer 1801 may also have other removable/non-removable, volatile/non-volatile computer storage media. FIG. 18 shows the mass storage device 1804 which may provide non-volatile storage of computer code, computer readable instructions, data structures, program modules, and other data for the computer 1801. The mass storage device 1804 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and/or the like.

Any quantity of program modules may be stored on the mass storage device 1804, such as the operating system 1805 and the noise reduction software 1806. Each of the operating system 1805 and the noise reduction software 1806 (or some combination thereof) may include elements of the program modules and the noise reduction software 1806. The audio data 1807 may also be stored on the mass storage device 1804. The audio data 1807 may be stored in any of one or more databases known in the art. Such databases may be DB2®, Microsoft® Access, Microsoft® SQL Server, Oracle®, MySQL, PostgreSQL, and/or the like. The databases may be centralized or distributed across locations within the network 1815.

A user may enter commands and information into the computer 1801 via an input device (not shown). Examples of such input devices include, but are not limited to, a keyboard, pointing device (e.g., a computer mouse, remote control), a microphone, a joystick, a scanner, tactile input devices such as gloves, and other body coverings, motion sensor, and/or the like These and other input devices may be connected to the one or more processors 1803 via a human machine interface 1802 that is coupled to the bus 1813, but may be connected by other interface and bus structures, such as a parallel port, game port, an IEEE 1394 Port (also known as a Firewire port), a serial port, network adapter 1808, and/or a universal serial bus (USB).

The display device 1811 may also be connected to the bus 1813 via an interface, such as the display adapter 1809. It is contemplated that the computer 1801 may include more than one display adapter 1809 and the computer 1801 may include more than one display device 1811. The display device 1811 may be a monitor, an LCD (Liquid Crystal Display), light emitting diode (LED) display, television, smart lens, smart glass, and/or a projector. In addition to the display device 1811, other output peripheral devices may be components such as speakers (not shown) and a printer (not shown) which may be connected to the computer 1801 via the Input/Output Interface 1810. Any step and/or result of the methods may be output (or caused to be output) in any form to an output device. Such output may be any form of visual representation, including, but not limited to, textual, graphical, animation, audio, tactile, and/or the like. The display device 1811 and computer 1801 may be part of one device, or separate devices.

The computer 1801 may operate in a networked environment using logical connections to one or more remote computing devices 1814a,b,c. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 1801 and a remote computing device 1814a,b,c may be made via a network 1815, such as a local area network (LAN) and/or a general wide area network (WAN). Such network connections may be through the network adapter 1808. The network adapter 1808 may be implemented in both wired and wireless environments. Such networking environments are conventional and commonplace in dwellings, offices, enterprise-wide computer networks, intranets, and the Internet.

Application programs and other executable program components such as the operating system 1805 are shown herein as discrete blocks, although it is recognized that such programs and components reside at various times in different storage components of the computing device 1801, and are executed by the one or more processors 1803 of the computer. An implementation of the noise reduction software 1806 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a computing device, an input signal comprising speech and non-speech;
determining, based on the input signal, a set of time-frequency (TF) samples of the input signal;
determining, based on the set of TF samples, a speech probability estimate for each TF sample of the set of TF samples;
determining, based on the speech probability estimate for each TF sample of the set of TF samples, one or more TF losses to be applied to one or more TF samples of the set of TF samples; and
generating, based on the one or more TF losses applied to the one or more TF samples, an output signal, wherein the output signal comprises less non-speech than the input signal.

2. The method of claim 1, wherein the speech probability estimate for the each TF sample of the set of TF samples is indicative of the speech being present in the each TF sample.

3. The method of claim 1, wherein the non-speech comprises stationary noise and non-stationary noise.

4. The method of claim 3, wherein the speech probability estimate further distinguishes the speech from the stationary noise and the non-stationary noise.

5. The method of claim 1, further comprising:
generating a labelled data set that comprises one or more input features and one or more indications indicative of the speech being present; and
providing the labelled data set to a machine learning model, wherein the machine learning model is configured to determine the speech probability estimate.

6. The method of claim 5, wherein the generating the labelled data set further comprises:
receiving, by the computing device, a set of speech samples;
applying, based on each of the set of speech samples, a speech weight to the each of the set of speech samples;
receiving, by the computing device, a set of non-speech samples;
applying, based on each of the set of non-speech sample, a non-speech weight to the each of the set of non-speech samples;
generating, by combining the speech weighted set of speech samples and the non-speech weighted set of non-speech samples, a speech augmented set; and
extracting one or more input features from the speech augmented set.

7. The method of claim 6, wherein the one or more extracted input features comprise Mel Frequency Cepstrum Coefficients (MFCCs), Phonemes, Senones, and Mel Spectrogram.

8. The method of claim 4, wherein the generating the labelled data set further comprises:
receiving, by the computing device, a set of speech samples;
applying, based on each of the set of speech samples, a speech weight to the each of the set of speech samples;
receiving, by the computing device, a set of non-speech samples;
applying, based on each of the set of non-speech sample, a non-speech weight to the each of the set of non-speech samples; and
determining, based on the speech weighted set of speech samples and the non-speech weighted set of non-speech sample, the one or more indications indicative of the speech present.

9. The method of claim 1, wherein the determining one or more TF losses further comprises:
determining, based on at least one of a priori signal to noise (SNR) ratio, the speech probability estimate, or a posteriori SNR, the one or more TF losses to be applied to the each of the set of TF samples.

10. The method of claim 1, wherein each of the set of time-frequency samples comprises a frequency bin narrowly filtered based on a frequency domain.

11. The method of claim 1, wherein the input signal comprises one or more pulse code modulation (PCM) signals.

12. A method comprising:
receiving, by a computing device, at least one input signal comprising a set of speech signals and a set of non-speech signals;
determining, based on the set of speech signals, a first set of time-frequency (TF) samples;
determining, based on a set of augmented signals, a second set of TF samples, wherein the set of augmented signals is based on the set of speech signals and the set of non-speech signals;
determining, based on the first set of TF samples and the second set of TF samples, one or more TF losses; and
generating, based on the one or more TF losses, an output signal, wherein the output signal comprises less non-speech than the at least one input signal.

13. The method of claim 12, wherein the set of non-speech signals comprises stationary noise and non-stationary noise.

14. The method of claim 12, further comprising:
applying a speech weight to each speech signal of the set of speech signals;
applying a non-speech weight to each non-speech signal of the set of non-speech signals; and
determining, based on the speech weighted set of speech signals and the non-speech weighted set of non-speech signals, the set of augmented signals.

15. The method of claim 12, further comprising:
determining, based on the first set of TF samples, a reference power spectral density (PSD) indicative of distribution of power of the first set of TF samples;
determining, based on the second set of TF samples, an augmented PSD indicative of distribution of power of the second set of TF samples; and
determining, based on the reference PSD and the augmented PSD, the one or more TF losses.

16. The method of claim 15, further comprising:
extracting one or more input features from one or more frames associated with the augmented PSD; and
determining a labelled data set that comprises the one or more input features and the one or more TF losses.

17. The method of claim 16, further comprising:
providing the labelled data set to a machine learning model that is configured to determine the one or more TF losses.

18. The method of claim 17, wherein the machine learning model is selected from among a plurality of machine learning models that produced a plurality of machine learning estimated TF losses during a plurality of epochs.

19. The method of claim 18, wherein the machine learning model is selected based on a set of validated speech signals and a set of non-speech signals using a Perceptual Evaluation of Speech Quality (PESQ) estimate iterated for each of the plurality of epochs.

20. The method of claim 12, wherein the one or more TF losses are indicative of one or more differences between the reference PSD and the augmented PSD.

21. The method of claim 12, wherein the one or more TF losses are within a range between 0 dB to a predetermined M dB.

22. The method of claim 12, wherein each of the first set of time-frequency (TF) samples comprises a frequency bin narrowly filtered based on a frequency domain, and each of the second set of TF samples comprises a frequency bin narrowly filtered based on the frequency domain.

23. A method comprising:
receiving, by a computing device, an input signal comprising speech and non-speech;
determining, based on the input signal, a set of time-frequency (TF) samples;
determining, based on one or more speech quality scores, one or more TF losses to be applied to one or more TF samples of the set of TF samples; and
generating, based on the one or more TF losses applied to the one or more TF samples, an output signal, wherein output signal comprises less non-speech than the input signal.

24. The method of claim 23, further comprising:
receiving, by the computing device, a set of speech signals and a set of non-speech signals;
generating, based on the set of speech signals and the set of non-speech signals that are augmented with one or more non-speech interferences, a set of augmented signals;
providing the set of augmented signals to a machine learning model that is configured to determine the one or more TF losses based on the set of augmented signals;
generating, based on the one or more TF losses applied to the set of augmented signals, a set of non-speech reduced signals; and
determining, based on the set of non-speech reduced signals, the one or more speech quality scores.

25. The method of claim 24, wherein the machine learning model is configured to apply the one or more TF losses to the set of augmented signals at each stage of training.

26. The method of claim 23, wherein the one or more speech quality scores are indicative of one or more Perceptual Evaluation of Speech Quality (PESQ) estimates.

27. The method of claim 23, further comprising:
determining, based on the one or more speech quality scores, one or more costs for the machine learning model.

28. The method of claim 23, wherein the one or more non-speech interferences comprise a reverberation, a pitch shift, and a tempo shift.

29. The method of claim 23, wherein each of the set of time-frequency samples comprises a frequency bin narrowly filtered based on a frequency domain.
